(19) United States
(12) Patent Application Publication
(10) Pub. No.: US 2015/0052329 A1
(43) Pub. Date: Feb. 19, 2015

(54) MEMORY CONTROL DEVICE, HOST COMPUTER, INFORMATION PROCESSING SYSTEM AND METHOD OF CONTROLLING MEMORY CONTROL DEVICE

(71) Applicant: Sony Corporation, Tokyo (JP)

(72) Inventor: Yasushi FUJINAMI, Tokyo (JP)

(21) Appl. No.: 14/451,068

(22) Filed: Aug. 4, 2014

(30) Foreign Application Priority Data
Aug. 14, 2013 (JP) 2013-168419

(51) Int. Cl. G06F 12/10

(52) U.S. Cl. CPC G06F 12/1027; G06F 2212/65
USPC 711/207

(57) ABSTRACT

A memory control device includes an address translation information holding portion that holds a portion of entries that are selected from address translation information containing a plurality of entries that associate a logical address with a physical address of a memory device; an address translation information acquisition unit that, when the entry containing the logical address specified by a host computer is not held in the address translation information holding portion, acquires the entry that is not held from the host computer and causes the address translation information holding portion to hold the entry; an address translation unit that translates the specified logical address into the physical address on the basis of the entries that are held in the address translation information holding portion; and a data transfer unit that executes a data transfer process in which transfer data is transferred using the translated physical address.

### CROSS REFERENCES TO RELATED APPLICATIONS

The present application claims priority to Japanese Priority Patent Application JP 2013-168419 filed in the Japan Patent Office on Aug. 14, 2013, the entire content of which is hereby incorporated by reference.

### BACKGROUND

The present disclosure relates to a memory control device, a host computer, an information processing system and a method of controlling the memory control device. More specifically, the present disclosure relates to a memory control device, a host computer, an information processing system and a method of controlling the memory control device, each of which are capable of performing address translation.

In the related art, in management of a memory device, address translation is performed to translate logical addresses into physical addresses of the memory device. This is because the address translation allows for the design of flexible programs and for ware leveling of nonvolatile memory. In the address translation, generally, address translation information containing a plurality of entries that associate a logical address with a physical address is used. The data size of the address translation information increases corresponding to an increase in storage capacity of the memory device. Therefore, in a configuration in which an address translation device such as a memory controller holds all entries of the address translation information, there is a concern that a margin of resources of the address translation device will be used up, and a concern that the cost of the address translation device will increase due to an increased provision of resources.

Therefore, a memory system is proposed in which a memory controller that performs the address translation holds a portion of the entries of the address translation information (for example, refer to Japanese Unexamined Patent Application Publication No. 2001-142774 and Japanese Unexamined Patent Application Publication No. 2007-280329). In the memory system, all the entries in the address translation information are stored together with user data in the nonvolatile memory, and the memory controller reads out a portion of the entries. The memory controller holds the entries, which are read, in Random Access Memory (RAM) of the memory controller itself. If the memory controller holds entries containing a logical address specified by the host computer in the RAM, the memory controller carries out the address translation on the basis of the entries. Meanwhile, if the memory controller does not hold an entry containing the specified logical address, the memory controller reads the entry from the nonvolatile memory and carries out the address translation. Once the logical address is translated into a physical address of the nonvolatile memory, the memory controller accesses the physical address and transfers user data between itself and the nonvolatile memory.

### SUMMARY

However, in the technology of the related art that is described above, there is a concern that the transfer rate of the data will be reduced. In the memory system described above, the memory controller may not read the address translation information from the nonvolatile memory and not transfer the user data at the same time. This is because the address translation information and the user data are both transferred via an interface (a data line or the like) between the memory controller and the nonvolatile memory. Therefore, when the address translation information is to be read, there is a problem in that the transfer of the user data is delayed by the amount of delay time taken in reading the address translation information.

It is desirable to increase the transfer rate of data in the information processing system.

According to an embodiment of the present disclosure, there is provided a memory control device and a method of controlling the memory control device. The memory control device includes an address translation information holding portion, an address translation information acquisition unit, an address translation unit, and a data transfer unit. The address translation information holding portion holds a portion of entries that are selected from address translation information containing a plurality of entries that associate a logical address with a physical address of a memory device. The address translation information acquisition unit, when the entry containing the logical address specified by a host computer is not held in the address translation information holding portion, acquires the entry that is not held from the host computer and causes the address translation information holding portion to hold the entry. The address translation unit translates the specified logical address into the physical address on the basis of the entries that are held in the address translation information holding portion. The data transfer unit executes a data transfer process in which transfer data is transferred using the translated physical address. Accordingly, an effect in which the entry that is not held in the address translation information holding portion is acquired from the host computer, and the transfer data is transferred is achieved.

The memory control device may further include an access frequency holding portion that, for each entry, holds an access frequency in relation to the logical address corresponding to the entry. The data transfer unit may further execute an initialization process including a process of selecting a portion of the entries, prioritizing the entries where the access frequency is high, and causing the address translation information holding portion to hold the selected entries. Accordingly, an effect in which a portion of the entries is selected, prioritizing the entries where the access frequency is high, is achieved.

The data transfer unit may execute an initialization process that further includes a process of acquiring all the entries from the memory device, and transferring the entries to the host computer. Accordingly, an effect in which all of the entries from the memory device are transferred to the host computer is achieved.

An address that is specified by the host computer may be the physical address or the logical address. When the address that is specified by the host computer is the logical address, the address translation unit may translate the logical address that is specified into the physical address on the basis of the entries. The data transfer unit may transfer the transfer data using a physical address that is specified by the host computer or the translated physical address. Accordingly, an effect in which transferring is performed using a physical address that is specified by the host computer or the translated physical address is achieved.

An address that is specified by the host computer may be either the logical address and the physical address or the logical address. When the address that is specified by the host computer is the logical address and the physical address, the address translation unit may update the entry corresponding to the specified logical address on the basis of the specified physical address. Accordingly, an effect in which, when the specified address is the logical address and the physical address, the entry corresponding to the specified logical address is updated on the basis of the specified physical address is achieved.

The host computer may supply the memory control unit with a command specifying the physical address or the logical address, and a notification indicating the logical address and the physical address that is newly allocated to the logical address. When the notification is supplied to the address translation unit, the address translation unit may update the entry corresponding to the logical address indicated by the notification on the basis of the physical address indicated by the notification. Accordingly, an effect in which, when the notification indicating the logical address and the physical address that is newly allocated to the logical address is supplied, the entry corresponding to the logical address indicated by the notification is updated on the basis of the physical address indicated by the notification is achieved.

According to another embodiment of the present disclosure, there is provided a host computer, including a holding portion, an address translation unit, and a command unit. The holding portion holds address translation information containing a plurality of entries that associate a logical address with a physical address of a memory device. The address translation unit, when a data size of transfer data that is transferred between the memory device and the host computer is less than a predetermined size, translates the logical address into the physical address on the basis of the entries that are held. The command unit specifies the logical address or the converted physical address and instructs a memory control device to transfer the transfer data. Accordingly, an effect in which the transfer data indicating the logical address or the translated physical address is transferred is achieved.

The host computer may further include an address translation information management unit that supplies the memory control device with a notification indicating the logical address and the physical address that is newly allocated to the logical address. The holding unit may further hold the physical address to which the logical address is not allocated as a free physical address. When a physical address is not associated with the logical address, the address translation unit may newly allocate the free physical address to the logical address. Accordingly, an effect in which, when a physical address is not associated with the logical address, the free physical address is newly allocated to the logical address, and the memory control device is supplied with a notification indicating the logical address and the physical address that is newly allocated to the logical address is achieved.

When the data size of the transfer data that is transferred between the memory device and the host computer is less than the predetermined size and the physical address is not associated with the logical address, the address translation unit may translate the logical address into the physical address on the basis of the entries that are held. Accordingly, an effect in which, when the data size of the transfer data is less than the predetermined size and the physical address is not associated with the logical address, the logical address is translated into the physical address is achieved.

According to still another embodiment of the present disclosure, there is provided an information processing system, including a host computer, an address translation holding portion, an address translation information acquisition unit, an address translation unit, and a data transfer unit. The host computer holds address translation information containing a plurality of entries that associate a logical address with a physical address of a memory device. The address translation information holding portion holds a portion of entries that are selected from the address translation information. The address translation information acquisition unit, when the entry containing the logical address specified by the host computer is not held in the address translation information holding portion, acquires the entry that is not held from the host computer and causes the address translation information holding portion to hold the entry. The address translation unit translates the specified logical address into the physical address on the basis of the entries that are held in the address translation information holding portion. The data transfer unit executes a data transfer process in which transfer data is transferred using the translated physical address. Accordingly, an effect in which the entry that is not held in the address translation information holding portion is acquired from the host computer, and the transfer data is transferred is achieved.

According to the present disclosure, a superior effect can be attained in that the transfer rate of data in the information processing system is improved.

Additional features and advantages are described herein, and will be apparent from the following Detailed Description and the figures.

### BRIEF DESCRIPTION OF THE FIGURES

FIG. 1 is an overall view showing an example of an information processing system in a first embodiment;

FIG. 2 is a block diagram showing a configuration example of a host computer in the first embodiment;

FIG. 3 is a block diagram showing a functional configuration example of a host computer in the first embodiment;

FIGS. 4A and 4B are diagrams showing an example of a data configuration of transfer commands in the first embodiment;

FIG. 5 is a diagram showing an example of address translation information in the first embodiment;

FIG. 6 is a block diagram showing a configuration example of a memory controller in the first embodiment;

FIG. 7 is a block diagram showing a functional configuration example of the memory controller in the first embodiment;

FIGS. 8A and 8B are diagrams showing an example of a data configuration of transfer requests in the first embodiment;

FIGS. 9A and 9B are diagrams showing an example of data held in an address translation information holding region and an address translation information management table holding region in the first embodiment;

FIG. 10 is a diagram showing an example of data held in an access frequency information holding region in the first embodiment;

FIG. 11 is a diagram showing an example of data held in a free physical address information holding region in the first embodiment;

FIG. 12 is a block diagram showing a configuration example of nonvolatile memory in the first embodiment;

FIG. 13 is a diagram showing an example of a usage state of a memory cell array in the first embodiment;

FIG. 14 is a diagram showing an example of data held in a management information region in the first embodiment;

FIG. 15 is a diagram showing an example of a data configuration of a physical page in the first embodiment;

FIG. 16 is a flowchart showing an example of a host-side process in the first embodiment;

FIG. 17 is a flowchart showing an example of a host-side initialization process in the first embodiment;

FIG. 18 is a flowchart showing an example of a controller-side process in the first embodiment;

FIG. 19 is a flowchart showing an example of a controller-side initialization process in the first embodiment;

FIG. 20 is a flowchart showing an example of a read control process in the first embodiment;

FIG. 21 is a flowchart showing an example of a data transfer process in the first embodiment;

FIG. 22 is a flowchart showing an example of a write control process in the first embodiment;

FIG. 23 is a flowchart showing an example of a free physical address allocation process in the first embodiment;

FIG. 24 is an example of a sequence diagram showing operations of the information processing system during initialization in a first embodiment;

FIG. 25 is an example of a sequence diagram showing operations of the information processing system during reading of user data in the first embodiment;

FIGS. 26A and 26B are examples of timing charts showing the operations of the memory controller during reading in the first embodiment;

FIG. 27 is a block diagram showing a functional configuration example of a host computer in a second embodiment;

FIGS. 28A and 28B are diagrams showing an example of a data configuration of transfer commands in the second embodiment;

FIG. 29 is a flowchart showing an example of a host-side process in the second embodiment;

FIG. 30 is a flowchart showing an example of a host-side initialization process in the second embodiment;

FIG. 31 is a flowchart showing an example of a controller-side initialization process in the second embodiment;

FIG. 32 is a flowchart showing an example of a read control process in the second embodiment;

FIG. 33 is a flowchart showing an example of a write control process in the second embodiment;

FIG. 34 is an example of a sequence diagram showing operations of the information processing system during initialization in the second embodiment; and

FIG. 35 is an example of a sequence diagram showing operations of the information processing system during reading in the second embodiment.

### DETAILED DESCRIPTION

Hereafter, description will be given of embodiments for realizing the present disclosure (hereinafter referred to as the “embodiments”). The description will be given in the following order.
1. First Embodiment (example in which address translation information pages are acquired from the host computer)
2. Second Embodiment (example in which the host computer performs the address translation when a number of pages to transfer is small)

### 1. First Embodiment

### Configuration Example of Memory System

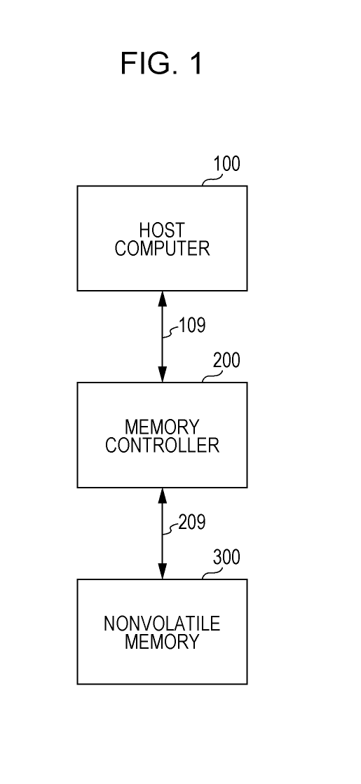

FIG. 1 is an overall view showing a configuration example of the information processing system in the first embodiment. The information processing system is provided with a host computer 100, a memory controller 200, and nonvolatile memory 300.

The host computer 100 controls the entire information processing system. The host computer 100 generates a transfer command that specifies a logical address and transfer data, and supplies the transfer command and the transfer data to the memory controller 200 via a signal line 109. The host computer 100 receives data or a status from the memory controller 200 via the signal line 109. The data contains the transfer data and the management information.

Here, the logical address is an address in an address space that is defined by the storage including the memory controller 200 and the nonvolatile memory 300. When an access unit of the logical address space is a page, the logical address of each page is referred to as a logical page address.

The transfer data is user data that is processed by a program or the like in the host computer 100, for example. The management information will be described in detail later. The transfer command is a command for performing transfer of the data. For example, the transfer command includes a write command that instructs the writing of data, and a read command that instructs the reading of data. The status is information that provides notification of an execution result of the transfer command and the state of the memory controller 200 or the like.

The memory controller 200 controls the nonvolatile memory 300. The memory controller 200 executes an initialization process when instructed by the host computer 100, when the power supply is turned on and the like. In the initialization process, the memory controller 200 acquires the address translation information from the nonvolatile memory 300 via a signal line 209, and transfers the address translation information to the host computer 100. Here, the address translation information is information for translating the logical address into the physical address of the nonvolatile memory 300. Specifically, the address translation information is information containing a plurality of entries in which a physical address is associated with a logical address. When the access unit of the nonvolatile memory 300 is a page, the physical address of each page is referred to as the physical page address.

In the initialization process, the memory controller 200 selects and holds a portion of the entries from in the address translation information. The reason not all the entries are held is that, as described above, there is a concern that the margin of the resources of the memory controller 200 will be used up, and a concern that the cost of the memory controller 200 will increase.

After the initialization process, once the memory controller 200 receives the transfer command from the host computer 100, the memory controller 200 translates the logical address specified by the transfer command into a physical address on the basis of the entries that are held. When the memory controller 200 is not holding an entry containing the specified logical address, the memory controller 200 acquires the entry from the host computer 100. A process in which conversion is performed from the logical address to the physical address is referred to as address translation. Due to the address translation, it is possible to perform a substitution process for excluding physical pages in which writing errors have occurred in the nonvolatile memory from being written to, to perform a ware leveling process in which the writing frequency of each memory cell is evened out and the like.

Once the address translation is performed, the memory controller 200 transfers the transfer data between the host computer 100 and the nonvolatile memory 300 via the signal line 109 and the signal line 209 using the translated physical addresses.

As described above, when a configuration is adopted in which the memory controller 200 acquires the entries of the address translation information from the host computer 100 via the signal line 109, the memory controller 200 can transfer the address translation information during the transferring of the transfer data. This is because, while the memory controller 200 transfers the transfer data via the signal line 209 between itself and the nonvolatile memory 300, it is possible to transfer the address translation information via the signal line 109 between the memory controller 200 and the host computer 100. In this manner, since the memory controller 200 can transfer the address translation information and the transfer data in parallel, it is possible to suppress the delay in the transfer of the transfer data.

Note that the memory controller 200 is an example of the memory control device according to an embodiment of the present disclosure.

The nonvolatile memory 300 stores data according to the control of the memory controller 200. The nonvolatile memory 300 stores the management information and the transfer data (the user data). The management information contains the address translation information, the access frequency information, and the free physical address information. Here, the access frequency information is information indicating, for each entry in the address translation information, the frequency with which a logical address corresponding to the entry is accessed. The free physical address information is information indicating a physical page address that is not associated with a logical address. The physical address that is not associated with a logical address is treated as a free physical address. The nonvolatile memory 300 supplies the management information to the memory controller 200 via the signal line 209 according to the control of the memory controller 200. The nonvolatile memory 300 transfers the transfer data according to the control of the memory controller 200.

The information processing system causes the nonvolatile memory 300 to store the data; however, the present disclosure is not limited to this configuration. In the case of a memory device that stores the data, a device other than the nonvolatile memory 300 (for example, an HDD: Hard Disk Drive) may be caused to store the data. The nonvolatile memory 300 is an example of the memory device according to an embodiment of the present disclosure.

The information processing system is provided with the memory controller 200 as the memory control device that controls the memory device; however, when a memory device other than the nonvolatile memory is used, a memory control device other than a memory controller such as an HDD controller may be provided. The memory controller 200 is configured to control one nonvolatile memory 300; however, a configuration may also be adopted in which a plurality of the nonvolatile memories 300 are controlled.

### Configuration Example of Host Computer

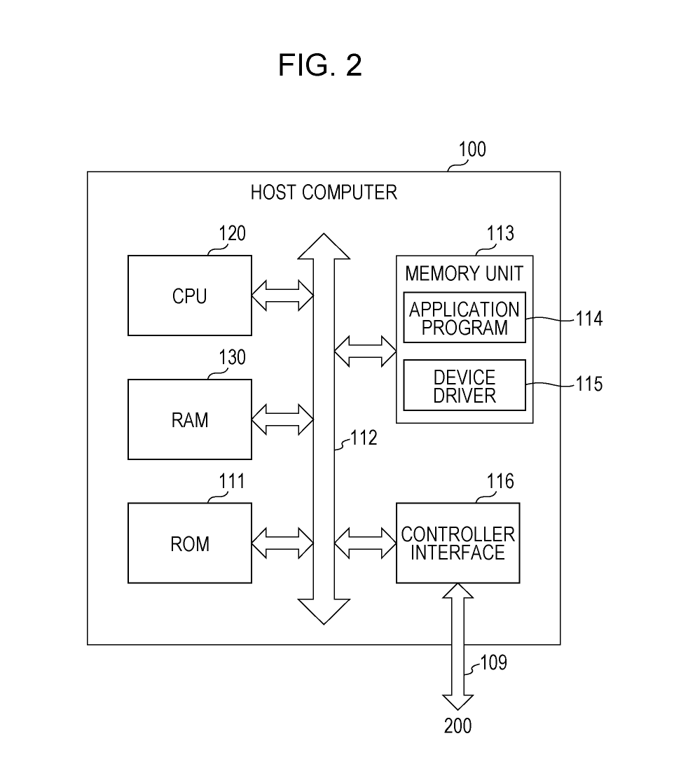

FIG. 2 is a block diagram showing a configuration example of the host computer 100 in the first embodiment. The host computer 100 is provided with a Central Processing Unit (CPU) 120, RAM 130, Read Only Memory (ROM) 111, a bus 112, a memory unit 113, and a controller interface 116. The memory unit 113 stores an application program 114, a device driver 115 and the like.

The CPU 120 controls the entire host computer 100. The RAM 130 temporarily holds the data that is necessary in the processes executed by the CPU 120. The ROM 111 stores the programs and the like that are executed by the CPU 120. The bus 112 is a common path for the CPU 120, the RAM 130, the ROM 111, the memory unit 113, and the controller interface 116 to exchange data between one another. The controller interface 116 is an interface for the host computer 100 and the memory controller 200 to exchange data and commands between one another.

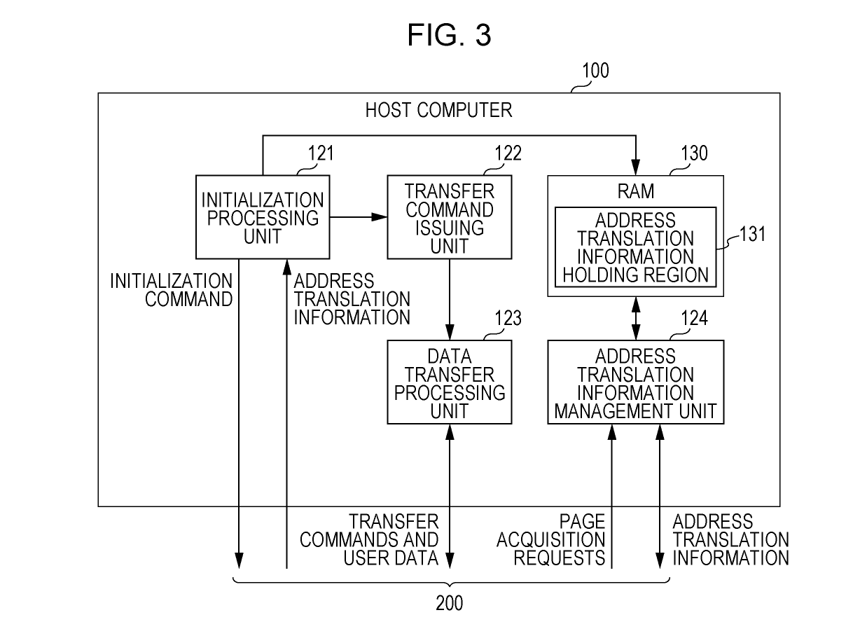

FIG. 3 is a block diagram showing a functional configuration example of the host computer 100 in the first embodiment. The host computer 100 is provided with an initialization processing unit 121, a transfer command issuing unit 122, a data transfer processing unit 123, the RAM 130, and an address translation information management unit 124. The RAM 130 is provided with an address translation information holding region 131. Note that the RAM 130 is an example of the holding unit according to an embodiment of the present disclosure.

The functions of the initialization processing unit 121 in FIG. 3 are realized by the CPU 120, the device driver 115, the controller interface 116 and the like in FIG. 2, for example. The functions of the transfer command issuing unit 122 and the data transfer processing unit 123 in FIG. 3 are realized by the CPU 120, the application program 114, the device driver 115, the controller interface 116 and the like in FIG. 2, for example. The functions of the address translation information management unit 124 in FIG. 3 are also realized by the CPU 120, the application program 114, the device driver 115, the controller interface 116 and the like in FIG. 2, for example.

The initialization processing unit 121 executes a predetermined initialization process when the power supply to the information processing system is turned on or the like. In the initialization process, the initialization processing unit 121 issues an initialization command for reading the address translation information, and receives the address translation information and the status from the memory controller 200. The initialization processing unit 121 causes the address translation information holding region 131 in the RAM 130 to hold the acquired address translation information. In the initialization command, the transfer destination of the data can be set to either the host computer 100 or the memory controller 200. The transfer destination of the initialization command for reading the address translation information is set to the host computer 100.

The initialization processing unit 121 individually issues the initialization command for reading the access frequency information, the initialization command for reading the free physical address information, and the initialization command for reading a portion of the entries of the address translation information. However, in the initialization commands described above, the transfer destination is set to the memory controller 200, of the host computer 100 and the memory controller 200. The memory controller 200 reads and holds a portion of the access frequency information, the free physical address information, and the address translation information from the nonvolatile memory 300 according to the initialization commands. Once the initialization process completes, the initialization processing unit 121 notifies the transfer command issuing unit 122 of the completion of the initialization.

Here, the initialization command further contains a reading start page address, a transfer pages number, and a transfer destination address. The reading start page address is the page address at which reading of the read data is started. The transfer destination address is the address of the transfer destination of the read data, and is set to an address in the RAM of either the host computer 100 or the memory controller 200.

The transfer command issuing unit 122 issues the transfer commands. The transfer commands include the read command and the write command. The read commands include the reading start page address, the transfer pages number, and the transfer destination address. The reading start page address is the page address at which reading of the read data is started. The transfer destination address is the address of the transfer destination of the read data, and is set to an address in the RAM of the host computer 100.

The write commands include the transfer source address, the writing start page address, and the transfer pages number. The transfer source address is the address of the transfer source of the write data, and is set to an address in the RAM of the host computer 100. The writing start page address is the logical page address at which writing of the write data is started.

Here, the transfer command specifies an address in a predetermined logical page address space that is defined by the storage including the memory controller 200. For example, 507,904 (=0x7c000) pages are defined as the logical page address space. The logical page addresses in the logical page address space are 0x00000 to 0x07bfff, for example. Here, numerical values prefixed with “0x” are represented in base 16. Hereinafter, numerical values prefixed with “0x” are represented in base 16, and those without are represented in base 10.

Meanwhile, in the nonvolatile memory 300, the storage capacity of the user data is, for example, 2 giga (=2,147,483,648) bytes, and the size of a physical page that does not contain redundant data is 4096 bytes. In this case, the physical page number of the nonvolatile memory 300 is 524,288 (=2,147,483,648/4096) pages, and the physical page addresses are, for example, 0x00000 to 0x07ffff. According to the equation shown below, the physical page number (524,288) has a margin of approximately 3% in relation to the logical page number (507,904).

524,288/507,904=1.03 Equation 1

The logical page number is set in this manner so that, when a physical page in the nonvolatile memory 300 is unusable due to a writing error or the like, free physical pages are secured such that it is possible to allocate a logical page instead. This is also in order to realize ware leveling in which the number of times each memory device in the nonvolatile memory 300 is re-written is evened out.

The size of the logical page address space described above is set on the premise of a configuration in which one nonvolatile memory 300 of a 2 gigabyte storage capacity is connected; however, the size depends on the storage capacity or the number of the nonvolatile memory 300 that are connected. For example, when the storage capacity or the number of the nonvolatile memory 300 is doubled, the size of the logical page address space is set to double.

The data transfer processing unit 123 transfers data between itself and the memory controller 200. When the transfer command is a write command, the data transfer processing unit 123 generates the user data to be written and supplies the user data together with the write command to the memory controller 200. Then, the data transfer processing unit 123 receives a status from the memory controller 200. Meanwhile, when the transfer command is a read command, the data transfer processing unit 123 supplies the read command to the memory controller 200, and receives the user data and the status that are read from the memory controller 200.

Note that, the term “page” is being used for the access unit of the logical address space and the physical address space; however, the term for the access unit is not limited to page. For example, the term may be sector or block. In relation to each of the logical address space and the physical address space, the name of the access unit and the data size are the same; however, a configuration may also be adopted in which the name of the access unit, the data size and the like of the logical address space and the physical address space are different.

Note that, the data transfer processing unit 123 is an example of the command unit according to an embodiment of the present disclosure.

The address translation information is held in the address translation information holding region 131. The address translation information contains a plurality of entries that associate a logical page address with a physical page address. However, valid physical page addresses are not allocated to logical page addresses to which user data is not written. In other words, invalid physical page addresses are allocated.

As described above, since the logical page number is 507,904, the number of entries in the address translation information is 507,904. Here, it is possible to store 1,024 entries in the address translation information in one page, which is the access unit. Therefore, the address translation information is managed by being divided into address translation information pages of 496 (=507,904/1,024) pages, each of which is formed of 1,024 entries.

The address translation information management unit 124 manages the address translation information. Specifically, when the address translation information management unit 124 receives a page acquisition request that requests the address translation information page from the memory controller 200, the address translation information management unit 124 reads the requested address translation information page from the RAM 130. The address translation information management unit 124 supplies the address translation information page, which is read, to the memory controller 200. When the address translation information management unit 124 receives the address translation information page from the memory controller 200, the address translation information management unit 124 updates the address translation information page with the same page number in the RAM 130 using the received address translation information page.

Note that, the address translation information management unit 124 reads the requested address translation information page in response to a page acquisition request from the memory controller 200; however, the present disclosure is not limited to this configuration. For example, the memory controller 200 may read the necessary address translation information page by directly accessing the address translation information holding region 131 in the host computer 100.

### Data Configuration Example of Transfer Command

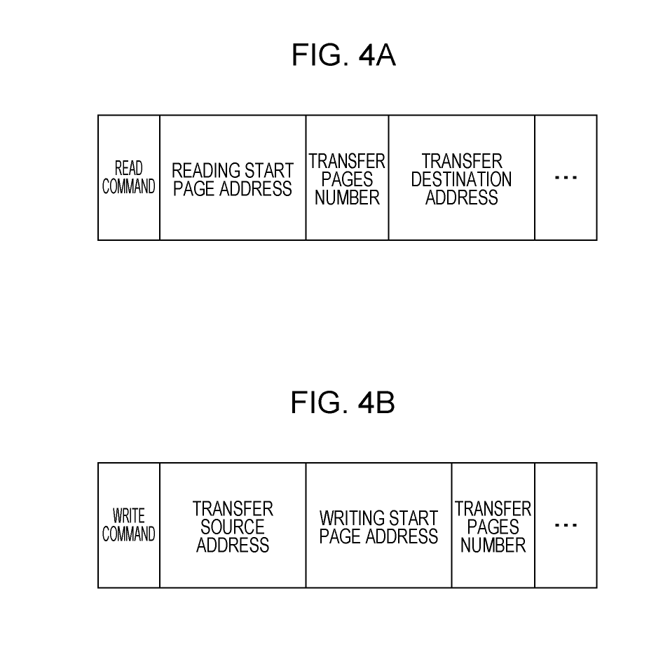

FIGS. 4A and 4B are diagrams showing an example of a data configuration of transfer commands in the first embodiment. FIG. 4A is a diagram showing an example of the data configuration of a read command. As shown in FIG. 4A, the read command contains the reading start page address, the transfer pages number, and the transfer destination address. The reading start page address is the address of the page at which to start reading the data, and in the case of reading user data, is set to a logical page address. The transfer pages number is set to the number of pages of the read data to be read in succession according to the read command. The transfer destination address is set to an address (a logical address or a physical address) of the RAM of the host computer 100. Note that, the initialization command for reading the management information further contains a transfer destination type. The transfer destination type is set to the host computer 100 or the memory controller 200. The transfer destination address of the initialization command is set to an address (a logical address or a physical address) of the RAM of the host computer 100 or the memory controller 200. The reading start page address of the initialization command is set to a physical page address. This is because address translation is not performed when reading the management information.

FIG. 4B is a diagram showing an example of the data configuration of a write command. As shown in FIG. 4B, the write command includes the transfer source address, the writing start page address, and the transfer pages number. The transfer source address is set to an address in the RAM of the host computer 100. The writing start page address is the logical page address at which to start writing the data, and in the case of writing user data, is set to a logical page address.

### Data Configuration Example of Address Translation Information

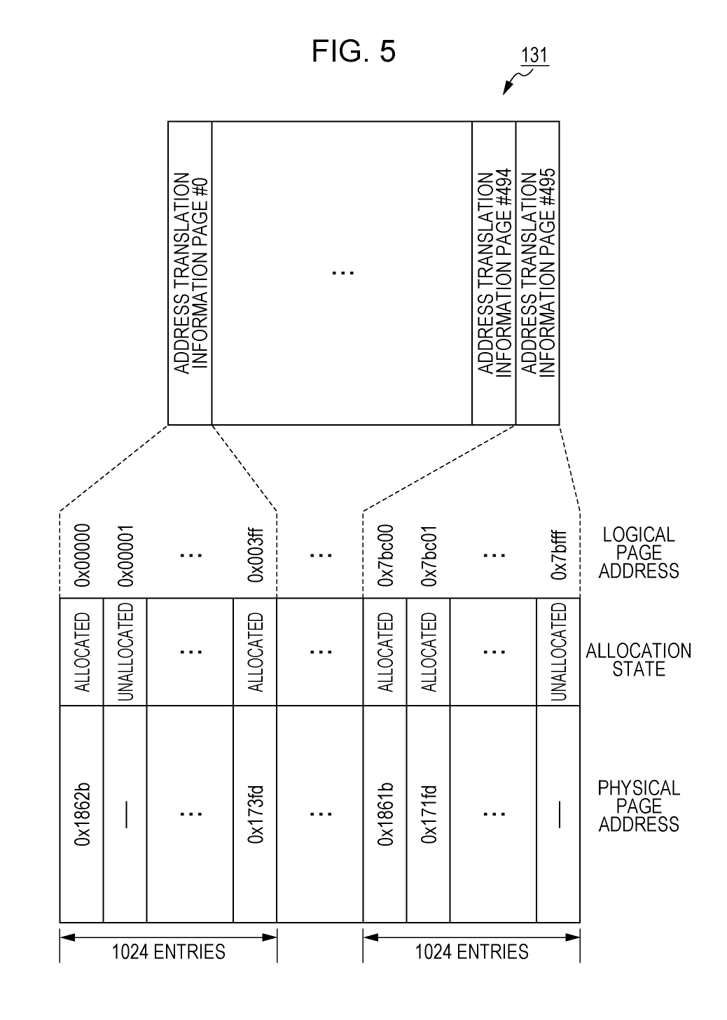

FIG. 5 is a diagram showing an example of address translation information in the first embodiment. The address translation information contains 496 address translation information pages. Each address translation information page contains 1,024 entries. Each entry contains the logical page address, the allocation state, and the physical page address.

The allocation state indicates whether or not a physical page address is allocated to a logical page address. A logical page address to which user data is not written is associated with an invalid physical page address, and the allocation state is set to “unallocated”. A logical page address to which user data is written is associated with a valid physical page address, and the allocation state is set to “allocated”. When the data that is written to an “allocated” logical page address is erased by an erasing command or the like, the allocation state is updated to “unallocated”, and the corresponding physical page address becomes invalid.

The data size of the allocation state is 1 byte, for example, the data size of the physical page address is 3 bytes, for example, and the data size of each entry formed therefrom is 4 bytes. Therefore, the data size of each address translation information page that is formed of 1,024 entries is 4,096 (=1,024×4) bytes. Therefore, the data size of all the address translation information that is formed of 496 pages is 2,031,616 (=496×4,096) bytes.

### Configuration Example of Memory Controller

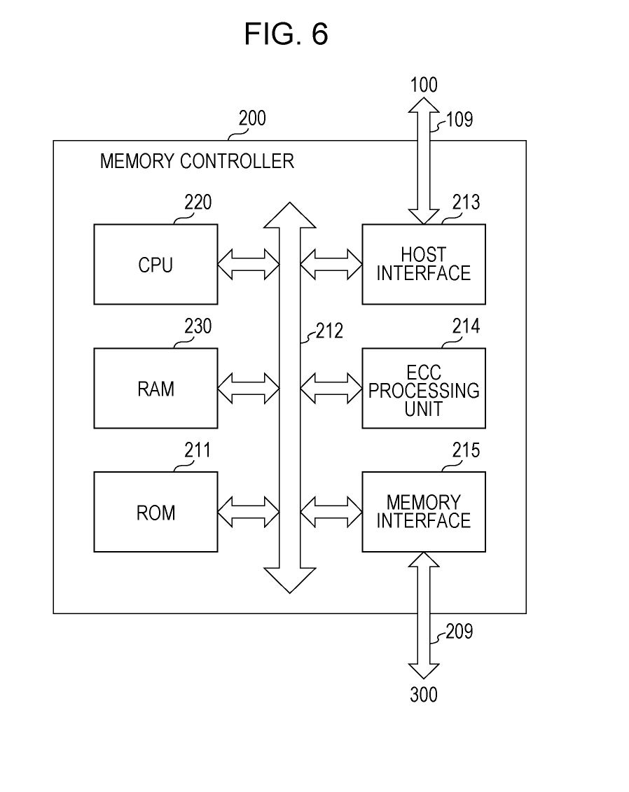

FIG. 6 is a block diagram showing a configuration example of the memory controller 200 in the first embodiment. The memory controller 200 is provided with a CPU 220, RAM 230, ROM 211, a bus 212, a host interface 213, an ECC processing unit 214, and a memory interface 215.

The CPU 220 controls the entire memory controller 200. The RAM 230 temporarily holds the data that is necessary in the processes executed by the CPU 220. The ROM 211 stores the programs and the like that are executed by the CPU 220. The bus 212 is a common path for the CPU 220, the RAM 230, the ROM 211, the host interface 213, the ECC processing unit 214, and the memory interface 215 to exchange data between one another. The host interface 213 is an interface for the memory controller 200 and the host computer 100 to exchange data and commands between one another.

The ECC processing unit 214 encodes the write data into an Error detection and Correction Code (ECC) and performs detection and correction of errors in the read data. In the ECC processing unit 214, Bose-Chaudhuri-Hocquenghem (BCH) encoding or Reed-Solomon (RS) encoding is used for the ECC. The memory interface 215 is an interface for the memory controller 200 and the nonvolatile memory 300 to exchange data and the like between one another.

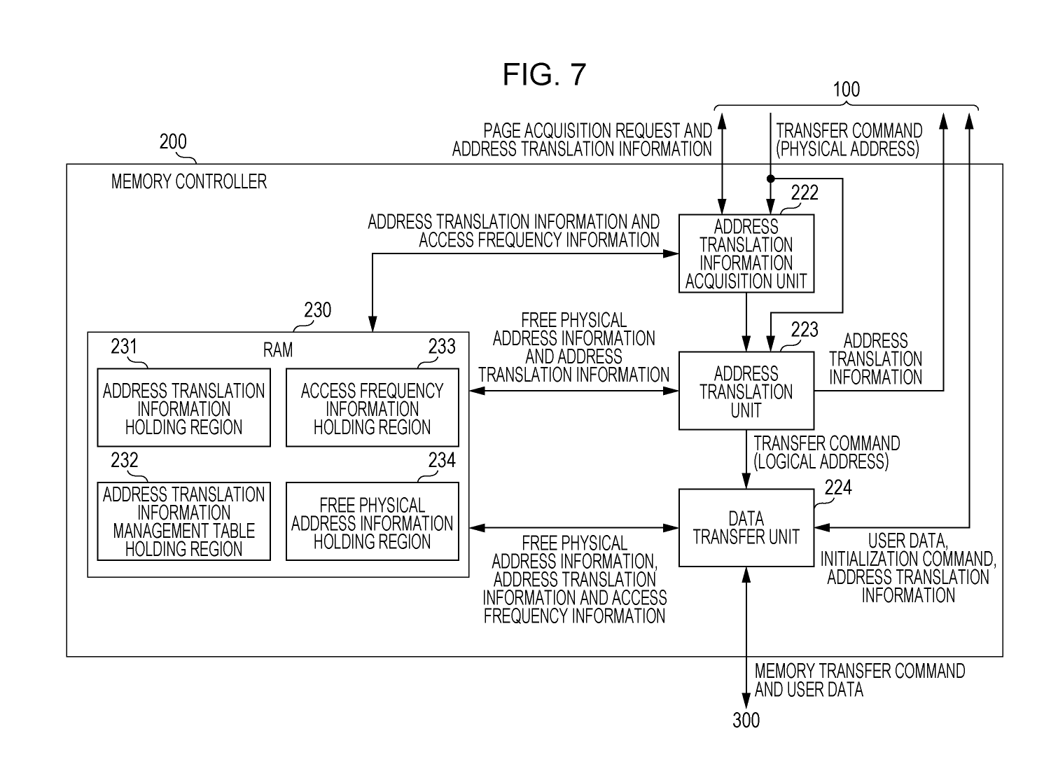

FIG. 7 is a block diagram showing a functional configuration example of the memory controller 200 in the first embodiment. The memory controller 200 is provided with an address translation information acquisition unit 222, an address translation unit 223, a data transfer unit 224, and the RAM 230. The RAM 230 is provided with an address translation information holding region 231, an address translation information management table holding region 232, an access frequency information holding region 233, and a free physical address information holding region 234. Note that, the RAM 230 is an example of the address translation information holding portion and the access frequency holding portion according to an embodiment of the present disclosure.

The function of the address translation information acquisition unit 222 in FIG. 7 is realized by the CPU 220 and the host interface 213 in FIG. 6, for example. The function of the address translation unit 223 in FIG. 7 is realized by the CPU 220 and the like in FIG. 6, for example. The function of the data transfer unit 224 in FIG. 7 is realized by the CPU 220, the host interface 213, the ECC processing unit 214, the memory interface 215, and the like in FIG. 6, for example.

The data transfer unit 224 realizes the predetermined initialization process and the data transfer process in which the user data is transferred, according to the control of the host computer 100. In the initialization process, when the data transfer unit 224 receives the initialization command for reading all the entries of the address translation information from the host computer 100, the data transfer unit 224 generates a read request from the initialization command.

The read request that is generated from the initialization command contains information indicating the transfer source page address, the transfer destination type, and the transfer destination address, for example. The transfer source page address is the page address at which the read data is read, and is set to a physical page address of the nonvolatile memory 300. The transfer destination type indicates whether the host computer 100 or the memory controller 200 is the transfer destination. The transfer destination address is the address of the transfer destination of the read data, and is set to the address of the host computer 100 or the memory controller 200.

The data transfer unit 224 reads all of the entries from the nonvolatile memory 300 according to a memory read command, and transfers the entries to the host computer 100.

When the data transfer unit 224 receives the initialization command for reading the access frequency information from the host computer 100, the data transfer unit 224 reads the access frequency information from the nonvolatile memory 300 using a memory read command. The data transfer unit 224 causes the access frequency information holding region 233 to hold the access frequency information that is read. The access frequency information contains information indicating, for each address translation information page, the number of times a logical page address in the page is accessed. The data transfer unit 224 reads the access number of each address translation information page that is held, performs weighting in which the value is multiplied by a predetermined coefficient (for example, 0.5), and writes the value back.

After the initialization process, the access number is increased each time one of the logical page addresses in the corresponding address translation information page is accessed. In a completion process that is executed when the power supply to the memory controller 200 is stopped or the like, the updated access frequency information in the memory controller 200 is written back to the nonvolatile memory 300.

By weighting the access number from the completion process of last time using the predetermined coefficient described above, it is possible to perform the weighting with a smaller coefficient (that is, the weight) the older the counted period is. For example, when the second initialization process is performed after the first completion process, the access number F1 of the first completion process is weighted with a coefficient of 0.5. When the third initialization process is performed after the second completion process, the access number F2 of the second completion process is weighted with a coefficient of 0.5. Since F2 contains the value of the first F1×0.5, the access number in which F2 is multiplied by 0.5 contains the value of F1×0.25. Similarly, the access number in which the access number F3 of the third completion process is multiplied by 0.5 contains the value of F2×0.25, and the value of F2×0.25 contains the value of F1×0.125. In this manner, the older the counted period is, the smaller the coefficient becomes in relation to the access number.

Note that, the data transfer unit 224 performs weighting in relation to the access number of the previous completion process; however, a configuration may also be adopted in which the weighting is not performed. In this case, the access number of the previous completion process is held as-is in the access frequency information holding region 233.

When the data transfer unit 224 receives the initialization command for reading the free physical address information from the host computer 100, the data transfer unit 224 reads the free physical address information from the nonvolatile memory 300 using a memory read command. The data transfer unit 224 causes the free physical address information holding region 234 to hold the free physical address information that is read.

When the data transfer unit 224 receives the initialization command for reading a portion of the address translation information, the data transfer unit 224 reads 32 address translation information pages from the nonvolatile memory 300, giving priority to address translation information pages with a high access frequency.

Note that, a configuration is adopted in which the data transfer unit 224 reads a portion of the address translation information from the nonvolatile memory 300; however, the present disclosure is not limited to this configuration. The data transfer unit 224 may acquire a portion of the address translation information from the host computer 100.

It is sufficient that the number of pages to be read be less than the total number of pages (496) of the address translation information, and the number not be limited to being 32 pages. A configuration is adopted in which a portion is read giving priority to pages with a high access frequency; however the present disclosure is not limited to this configuration. For example, the memory controller 200 may read 32 pages in ascending order by page number.

The data transfer unit 224 causes the address translation information holding region 231 to hold the address translation information pages that are read. The data transfer unit 224 generates the address translation information management table and causes the address translation information management table holding region 232 to hold the table. The configuration of the address translation information management table will be described later.

In the data transfer process, the data transfer unit 224 generates a transfer request from the transfer command. For example, the transfer requests are divided into a number of transfer requests equal to that of the transfer pages number. The transfer requests include read requests and write requests. The read request contains information indicating the transfer source page address and the transfer destination address, and the write request contains information indicating the transfer source address and the transfer destination page address.

When the write request is issued, the data transfer unit 224 supplies the memory write commands in sequential order to the nonvolatile memory 300. The data transfer unit 224 encodes the write data from the host computer 100 into an ECC and transfers the ECC to the nonvolatile memory 300. Meanwhile, when the read request is issued, the data transfer unit 224 supplies the memory read commands in sequential order to the nonvolatile memory 300, and receives the read data from the nonvolatile memory 300. The data transfer unit 224 performs detection and correction of errors in the read data, and transfers the corrected read data to the host computer 100. The data transfer unit 224 generates a status and supplies the status to the host computer 100. Note that notation of the status is omitted from FIG. 7.

When the entries corresponding to the logical page address specified by the transfer command are not held in the RAM 230, the address translation information acquisition unit 222 acquires the entries from the host computer 100. Specifically, when the address translation information acquisition unit 222 receives the transfer command from the host computer 100, the address translation information acquisition unit 222 obtains the number of the address translation information page that contains the logical page address specified in the transfer command. Since the address translation information page is formed of 1,024 entries, the quotient may be obtained by dividing the specified logical page address by 0x00400 (=1,024). The quotient indicates the number of the corresponding address translation information page.

For example, a case will be considered in which the address translation information pages are “0” to “495”, and the specified logical page address is 0x013ff. The quotient obtained by dividing 0x013ff by 0x00400 is 0x00004. Therefore, the number of the address translation information page containing the specified logical page address is “4”.

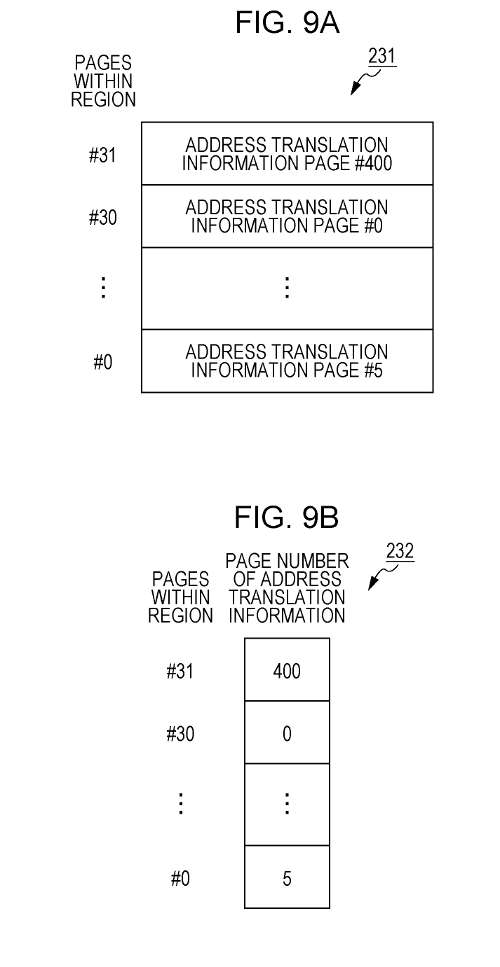

The address translation information acquisition unit 222 determines whether or not the address translation information page of the calculated number is held in the RAM 230. When the address translation information page is not held in the RAM 230, the address translation information acquisition unit 222 issues a page acquisition request that requests the address translation information page that is not held, and supplies the request to the host computer 100. The page request contains the page number of the address translation information page to be requested, for example. When the requested address translation information page is received from the host computer 100, the address translation information acquisition unit 222 looks up the access frequency information and the address translation information in the RAM 230. The address translation information acquisition unit 222 replaces the address translation information page with the lowest access frequency of the address translation information pages held in the RAM 230 with the address translation information page received from the host computer 100. The address translation information acquisition unit 222 updates the address translation information management table due to the replacement of the address translation information page. The update content will be described in detail later in FIGS. 9A and 9B.

When the address translation information page of the calculated number is held in the RAM 230, or when the address translation information page is received, the address translation information acquisition unit 222 notifies the address translation unit 223 that the corresponding entry is being held.

The address translation unit 223 translates a logical page address that is specified by a transfer command into a physical page address on the basis of the entries that are held in the RAM 230. When the address translation unit 223 is notified that the entry corresponding to the logical page address that is specified in the transfer command is held, the address translation unit 223 obtains the position of the entry corresponding to the specified logical page address. Since the address translation information page is formed of 1,024 entries, the remainder may be obtained by dividing the specified logical page address by 0x00400 (=1,024). The remainder indicates the position of the corresponding entry in the address translation information page.

For example, a case will be considered in which the specified logical page address is 0x013ff. When 0x013ff is divided by 0x00400, the quotient is 0x00004 and the remainder is 0x003ff. Therefore, the 1,023 (=0x003ff)-th entry in the address translation information page where the page number is “4” corresponds to the specified logical page address. The address translation unit 223 reads the entry from the RAM 230 and looks up the allocation state thereof.

In regard to the entry that is looked up, when the physical page address is unallocated, the address translation unit 223 looks up the free physical address information, selects one of the free physical page addresses, and updates the free physical address information. The address translation unit 223 updates the physical page address of the entry that is looked up using the selected physical page address, and updates the allocation state corresponding to the physical page address to “allocated”.

The address translation unit 223 supplies the updated address translation information page to the host computer 100. The address translation unit 223 translates the specified logical page address into the corresponding physical page address on the basis of the updated address translation information page, and supplies a transfer command with the translated address to the data transfer unit 224.

Meanwhile, in regard to the entry that is looked up, when the physical page address is allocated, the address translation unit 223 translates the specified logical page address to the physical page address that corresponds to the logical page address. The address translation unit 223 supplies the transfer command with the translated address to the data transfer unit 224.

### Data Configuration Example of Transfer Request

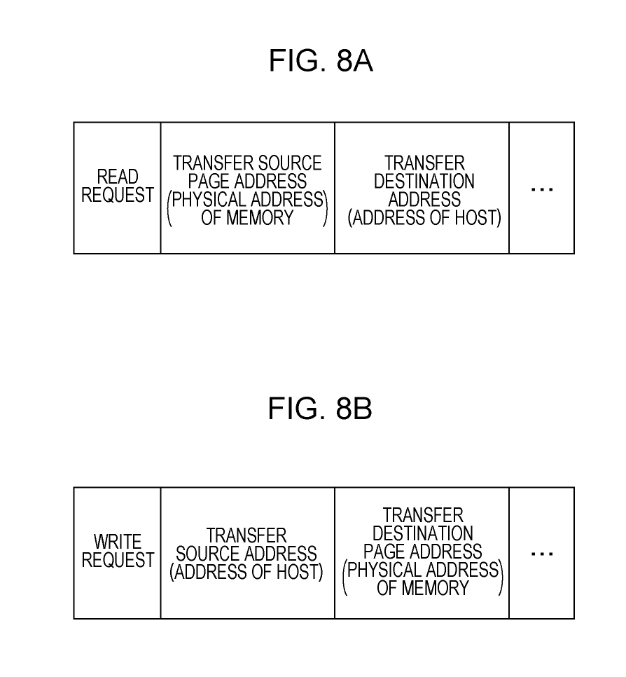

FIGS. 8A and 8B are diagrams showing an example of the data configuration of transfer requests in the first embodiment. FIG. 8A is a diagram showing an example of the data configuration of a read request. As shown in FIG. 8A, the read request contains the transfer source page address, and the transfer destination address. The transfer source page address is set to a physical page address of the nonvolatile memory 300. The transfer destination address is set to an address in the RAM of the host computer 100. Note that, the read request used when reading the management information further contains a transfer destination type. The transfer destination type is set to the host computer 100 or the memory controller 200. The transfer destination address is set to an address in the RAM of the host computer 100 or the memory controller 200.

FIG. 8B is a diagram showing an example of the data configuration of a write request. As shown in FIG. 8B, the write request contains the transfer source address, and the transfer destination page address. The transfer source address is set to an address in the RAM of the host computer 100. The transfer destination page address is set to a physical page address of the nonvolatile memory 300. Note that, the write request used when writing the management information further includes a transfer source type. The transfer source type is set to the host computer 100 or the memory controller 200. The transfer source address is set to an address in the RAM of the host computer 100 or the memory controller 200.

FIGS. 9A and 9B are diagrams showing an example of data held in the address translation information holding region 231 and the address translation information management table holding region 232 in the first embodiment. FIG. 9A is a diagram showing an example of data held in the address translation information holding region 231. As shown in FIG. 9A, in the address translation information holding region 231, an address translation information page is held in each of the pages #0 to #31 in the region. Since the data size of each of the address translation information pages is 4096 bytes, 131,072 (=4096×32) bytes of data are held in the address translation information holding region 231.

FIG. 9B is a diagram showing an example of data held in the address translation information management table holding region 232. As shown in FIG. 9B, the address translation information management table holding region 232 holds the page numbers of address translation information page that are held in each of the pages #0 to #31 in the region. As exemplified in FIGS. 9A and 9B, the memory controller 200 holds the page numbers in a different region from the address translation information holding region 231; however, they may be held in the same region. In this case, an address translation information page and the page number thereof are held in each of the pages in the region. When the memory controller 200 replaces an address translation information page in the address translation information with a new page, the memory controller 200 updates the page in the region corresponding to the page that is replaced in the address translation information management table with the page number of the address translation information page.

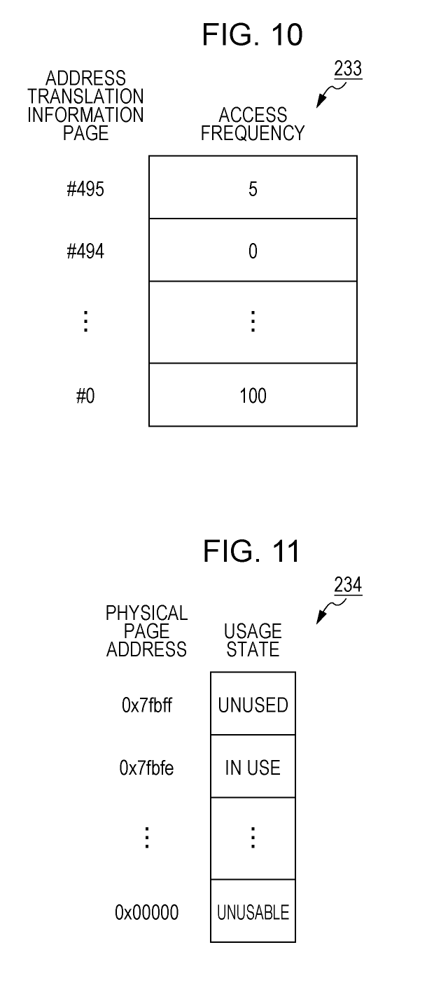

FIG. 10 is a diagram showing an example of data held in the access frequency information holding region 233 in the first embodiment. The access frequency information holding region 233 holds information (for example, the access number) indicating the access frequency of the logical page address of each page of #0 to #495 of the address translation information pages. The size of each access number is 4 bytes, for example, and the data size of all the access frequency information including the access numbers of each of 496 pages is 1,984 (=496×4) bytes.

FIG. 11 is a diagram showing an example of data held in the free physical address information holding region 234 in the first embodiment. The free physical address information holding region 234 holds information indicating the usage states of each of the physical page addresses of 0x00000 to 0x7fbff.

The usage states indicate either “in use”, “unused”, or “unusable” as the state of the corresponding physical page address. The usage state “in use” indicates that a logical page address is allocated to the physical page address, and “unused” indicates that a logical page address is not allocated to the physical page address. The unused physical page address is treated as a free physical page address. The usage state “unusable” indicates that the physical page address is presently not being used and future use is not recommended due to reasons such as the occurrence of an error. Since the usage state represents three states with 2 bits, the data size of the free physical address information formed of the usage states of each of the 523,264 physical page addresses is 130,816 (=523,264×2/8) bytes. Since the data size of the access unit (the page) is 4096 bytes, the free physical address information is managed by being divided into 32 (=30,816/4096) free physical address information pages. Each free physical address information page contains 16,352 (=523,264/32) usage states.

### Configuration Example of Nonvolatile Memory

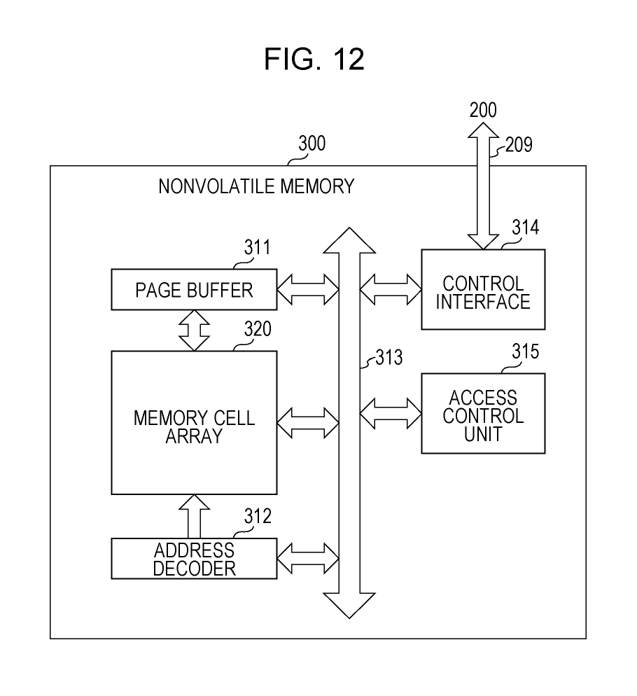

FIG. 12 is a block diagram showing a configuration example of the nonvolatile memory 300 in the first embodiment. The nonvolatile memory 300 is provided with a page buffer 311, a memory cell array 320, an address decoder 312, a bus 313, a control interface 314, and an access control unit 315.

The page buffer 311 holds the write data and the read data in page units according to the control of the access control unit 315. The memory cell array 320 is provided with a plurality of memory cells that are arranged in a matrix. A nonvolatile memory device is used for each memory cell. Specifically, NAND-type or NOR-type flash memory, Resistive RAM (ReRAM), Phase-Change RAM (PCRAM), Magnetoresistive RAM (MRAM) or the like may be used as the memory device. The address decoder 312 analyses the address that is specified by the memory transfer command, and selects the memory cell corresponding to the address. The bus 313 is a common path for the page buffer 311, the memory cell array 320, the address decoder 312, the control interface 314, and the access control unit 315 to exchange data between one another. The control interface 314 is an interface for the memory controller 200 and the nonvolatile memory 300 to exchange data, requests and the like between one another.

The access control unit 315 accesses the memory cell array 320 and reads or writes data. When the access control unit 315 receives a memory write command, the access control unit 315 causes the page buffer 311 to hold the write data. The access control unit 315 supplies the address that is specified by the memory write command to the address decoder 312. When the memory cell is selected by the address decoder 312, the access control unit 315 controls a driver (not shown), causing the driver to write data to the memory cell.

When the access control unit 315 receives a memory read command, the access control unit 315 supplies the address that is specified by the memory read command to the address decoder 312. When the memory cell is selected by the address decoder 312, the access control unit 315 controls the driver to cause the driver to read the data stored in the memory cell and the page buffer 311 is caused to hold the data. When the read data is held in the page buffer 311, the access control unit 315 controls the control interface 314 to output the read data to the memory controller 200.

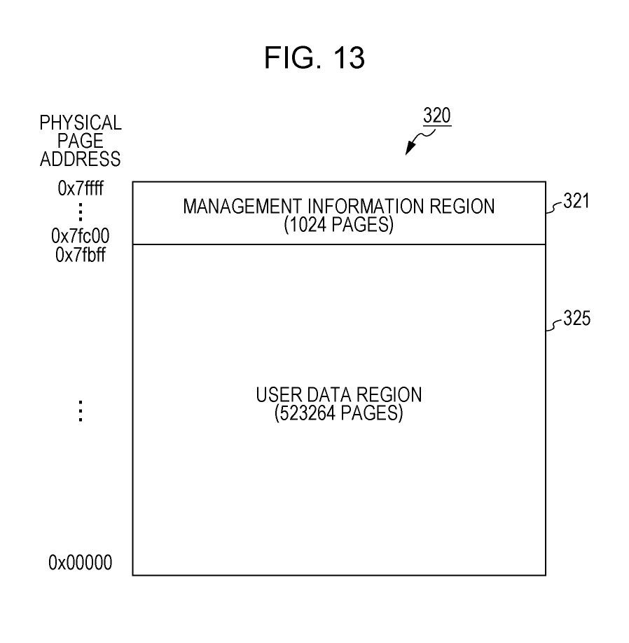

FIG. 13 is a diagram showing an example of the usage state of the memory cell array 320 in the first embodiment. The memory cell array 320 is provided with a management information region 321 and a user data region 325. The address translation information, the free physical address information, and the access frequency information are held in the management information region 321. The user data is held in the user data region 325. The number of physical pages that can be stored in the memory cell array 320 is, 524,288 pages, for example. Of these, a region formed of 523,264 pages, for example, is used as the user data region 325, and the region that is formed of the remaining 1,024 pages is used as the management information region 321.

Here, since the memory controller 200 is configured to perform the address translation, even if a writing error occurs in the user data region 325, the memory controller 200 can allocate a free physical page address instead. Since a writing error may also occur in the management information region 321, it is preferable that the memory controller 200 also perform address translation in the initialization command of the management information. However, in order to facilitate explanation, address translation is not performed in the initialization command in relation to the management information region 321. Note that, a configuration may be adopted in which the memory controller 200 also performs the address translation in the initialization command of the management information.

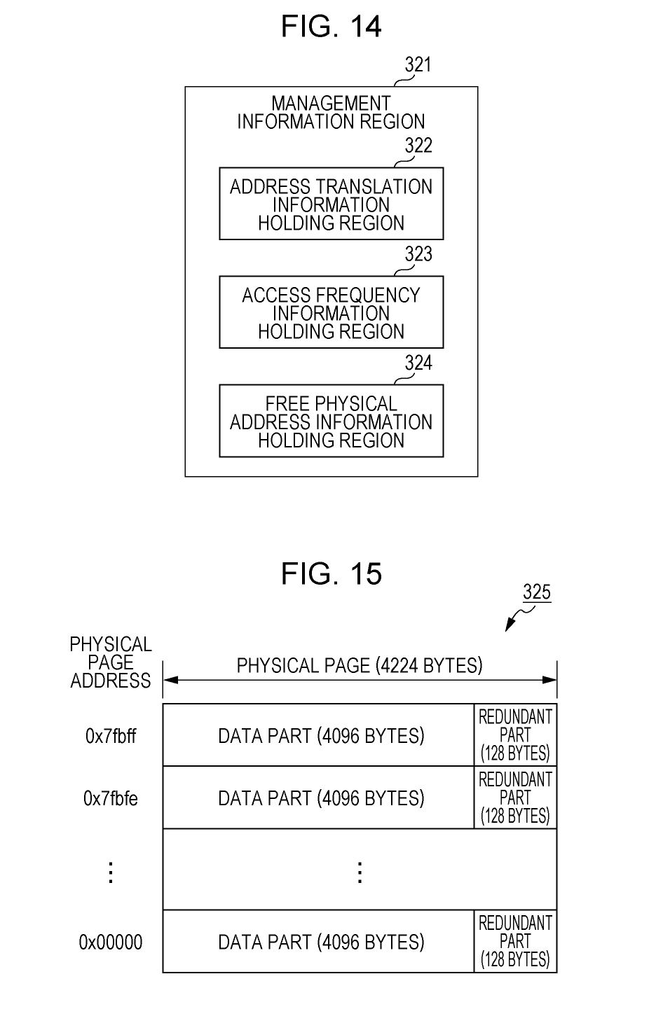

FIG. 14 is a diagram showing an example of the data held in the management information region 321 in the first embodiment. The management information region 321 is provided with an address translation information holding region 322, an access frequency information holding region 323, and a free physical address information holding region 324. Address translation information that is formed of 496 address translation information pages is held in the address translation information holding region 322. All the pages of address translation information are transferred to and held by the host computer 100. A portion of the address translation information (for example, 32 pages) is transferred to and held in the memory controller 200.

The access frequency information is held in the access frequency information holding region 323. The free physical address information is held in the free physical address information holding region 324. The access frequency information and the free physical address information are transferred to and held in the memory controller 200.

### Data Configuration Example of Physical Page

FIG. 15 is a diagram showing an example of a physical page that is stored in the user data region in the first embodiment. Each physical page is provided with a data part and a redundant part. Of the physical page, the data part is a portion containing the original data before being ECC encoded. The redundant part contains the parity that is generated from the original data in the encoding and the like. The size of the data part is 4,096 bytes, for example, and the size of the redundant part is 128 bytes, for example. The size of the physical page formed of the data part and the redundant part is 4,224 bytes, for example.

### Operation Example of Host Computer

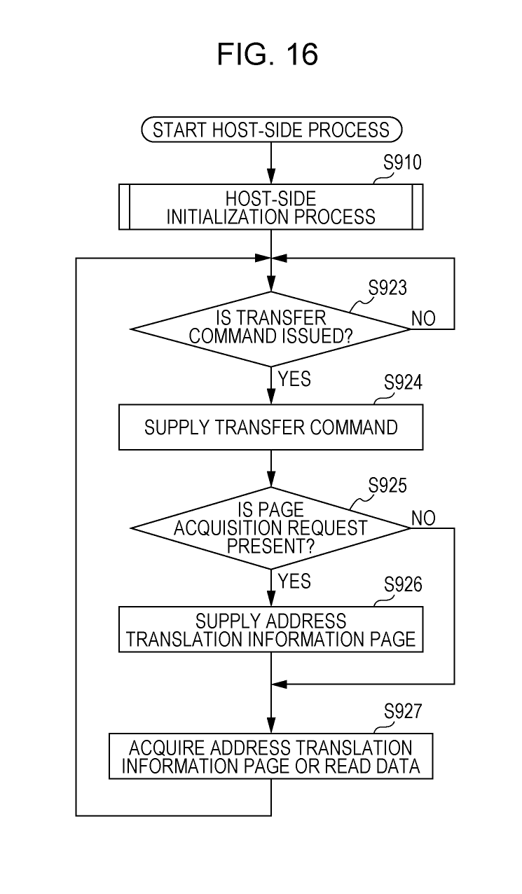

FIG. 16 is a flowchart showing an example of a host-side process in the first embodiment. The host-side process is started by the host computer 100 when the power supply to the information processing system is turned on, for example.

First, the host computer 100 executes the host-side initialization process (step S910). The host computer 100 executes the application program 114 or the like, and issues a transfer command if necessary. The host computer 100 determines whether or not the transfer command is issued (step S923). If the transfer command is not issued (step S923: No), the host computer 100 returns to step S923.

When the transfer command is issued (step S923: Yes), the host computer 100 supplies a transfer command to the memory controller 200 via the controller interface 116 (step S924). If the transfer command is a write command, the write data is supplied together with the transfer command.

The host computer 100 determines whether or not there is a page acquisition request from the memory controller 200 (step S925). When the page acquisition request is present (step S925: Yes), the host computer 100 supplies the address translation information page that is requested by the page acquisition request to the memory controller 200 (step S926).

When the page acquisition request is not present (step S925: No), or after step S926, the host computer 100 acquires the read data that is read by the memory controller 200. When the updated address translation information page is supplied from the memory controller 200, the host computer 100 updates the address translation information that is held using the address translation information page (step S927). After step S927, the host computer 100 returns to step S923.

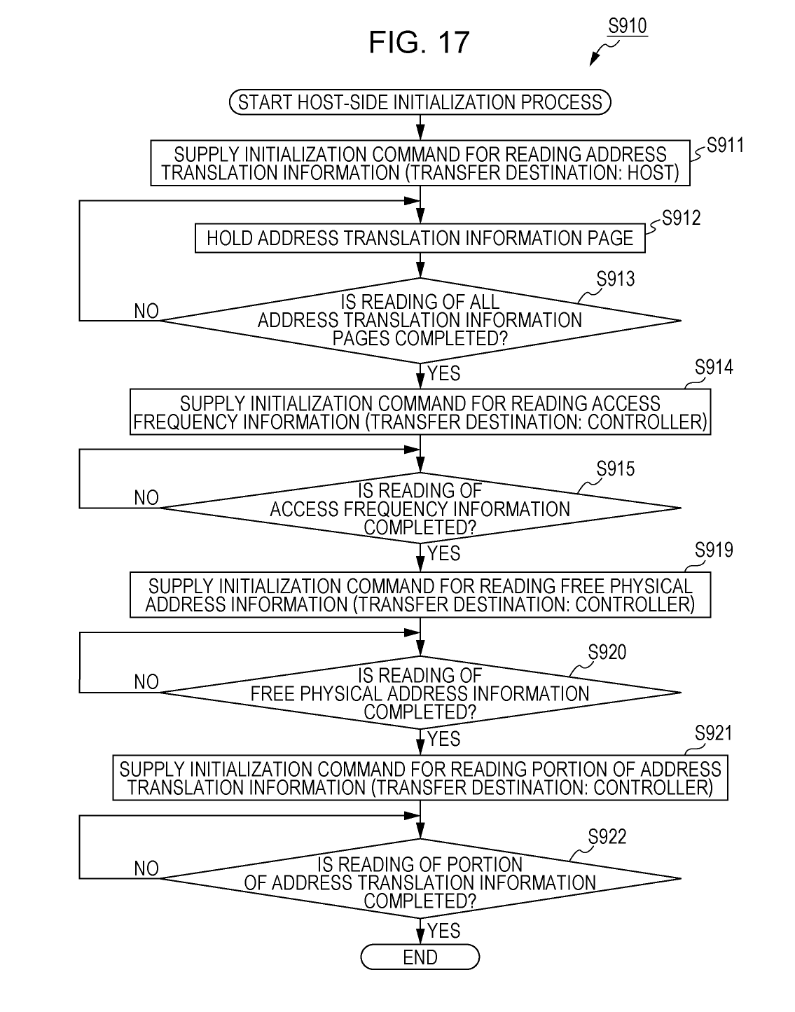

FIG. 17 is a flowchart showing an example of the host-side initialization process in the first embodiment. The host computer 100 issues an initialization command for reading the address translation information. In the initialization command, the reading start page address is set to the physical page address of the address translation information holding region 322, and the transfer destination of the address translation information, which is the read data, is set to the host computer 100. The host computer 100 supplies the initialization command to the memory controller 200 (step S911).

The host computer 100 holds the address translation information page that is read (step S912). The host computer 100 determines whether or not the reading of all the address translation information pages is completed on the basis of the status from the memory controller 200 (step S913). If the reading of all the pages is not completed (step S913: No), the host computer 100 returns to step S912.

If the reading of all the pages is completed (step S913: Yes), the host computer 100 issues an initialization command for reading the access frequency information. In the initialization command, the reading start page address is set to the physical page address of the access frequency information holding region 323, and the transfer destination of the access frequency information, which is the read data, is set to the memory controller 200. The host computer 100 supplies the initialization command to the memory controller 200 (step S914). The host computer 100 determines whether or not the reading of the access frequency information is completed on the basis of the status from the memory controller 200 (step S915). If the reading of the access frequency information is not completed (step S915: No), the host computer 100 returns to step S915.

If the reading of the access frequency information is completed (step S915: Yes), the host computer 100 issues an initialization command for reading the free physical address information. In the initialization command, the reading start page address is set to the physical page address of the free physical address information holding region 324, and the transfer destination of the free physical address information, which is the read data, is set to the memory controller 200. The host computer 100 supplies the initialization command to the memory controller 200 (step S919). The host computer 100 determines whether or not the reading of the free physical address information is completed on the basis of the status from the memory controller 200 (step S920). If the reading of the free physical address information is not completed (step S920: No), the host computer 100 returns to step S920.

If the reading of the free physical address information is completed (step S920: Yes), the host computer 100 issues an initialization command for reading a portion of the address translation information. In the initialization command, the reading start page address is set to the physical page address of the address translation information holding region 322, and the transfer destination of the address translation information, which is the read data, is set to the memory controller 200. The host computer 100 supplies the initialization command to the memory controller 200 (step S921). The host computer 100 determines whether or not the reading of a portion of the address translation information is completed on the basis of the status from the memory controller 200 (step S922). If the reading of a portion of the address translation information is not completed (step S922: No), the host computer 100 returns to step S922. On the other hand, if the reading of a portion of the access frequency information is completed (step S922: Yes), the host computer 100 ends the host-side initialization process.

Note that, a configuration is adopted in which the information processing system reads each of all the address translation information, the access frequency information, the free physical address information, and a portion of the address translation information all in the initialization process; however the present disclosure is not limited to this configuration. For example, a configuration may be adopted in which, when the memory controller 200 holds a portion of the address translation information regardless of the access frequency, the information processing system does not perform the reading of the access frequency information in the initialization process. The information processing system may be configured such that, when the host computer 100 is already holding the address translation information before the initialization process and the like, the host computer 100 does not perform the reading in the initialization process. For example, in a configuration in which the host computer 100 holds the address translation information that is read in the first initialization process in a nonvolatile memory device other than the nonvolatile memory 300, it is unnecessary to read the address translation information in the second initialization process.

In the information processing system, the transfer destination of the access frequency information and the free physical address information is set to the memory controller 200; however, the transfer destination may be set to the host computer 100 instead of the memory controller 200. When the transfer destination of the access frequency information is set to the host computer 100, the host computer 100 performs the management of the access frequency information. The host computer 100 determines the address translation information pages to be held in the memory controller 200 based on the access frequency and instructs the memory controller 200. When the transfer destination of the free physical address information is set to the host computer 100, the host computer 100 allocates a free physical address to an unallocated logical page. The host computer 100 updates the address translation information pages, and supplies the updated pages to the memory controller 200.

In the initialization process, the order of the reading of all the address translation information, the access frequency information, the free physical address information, and the portion of the address translation information is not limited to this order. For example, in the reading of a portion of the address translation information, in a configuration in which the access frequency information is not looked up, the order of the reading of each of the portion of the address translation information and the access frequency information is arbitrary.

### Operation Example of Memory Controller

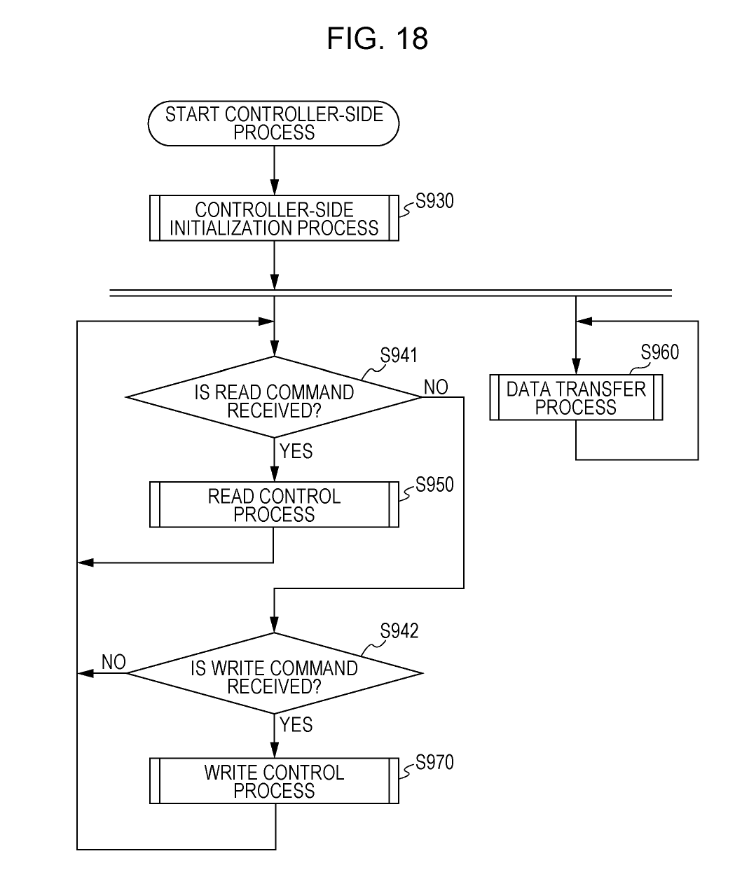

FIG. 18 is a flowchart showing an example of the controller-side process in the first embodiment. The operation is started by the memory controller 200 when the power supply to the information processing system is turned on, for example. First, the memory controller 200 executes the controller-side initialization process (step S930).

The memory controller 200 executes the data transfer process (step S960). The memory controller 200 determines whether or not the read command is received (step S941). If the read command is received (step S941: Yes), the memory controller 200 executes the read control process (step S950).

If the read command is not received (step S941: No), the memory controller 200 determines whether or not the write command is received (step S942). If the write command is received (step S942: Yes), the memory controller 200 executes the write control process (step S970). When the write command is not received (step S942: No), or after step S950 or 5970, the memory controller 200 returns to step S941.

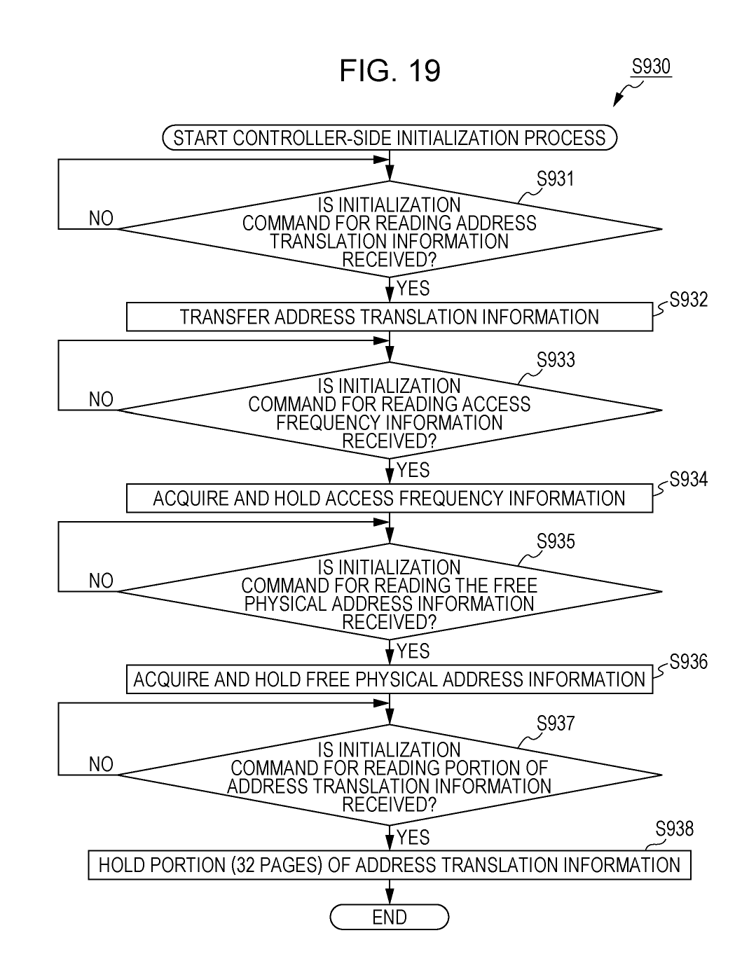

FIG. 19 is a flowchart showing an example of the controller-side initialization process in the first embodiment. The memory controller 200 determines whether or not the initialization command for reading the address translation information is received (step S931). If the initialization command for reading of the address translation information is not received (step S931: No), the memory controller 200 returns to step S931. On the other hand, if the initialization command is received (step S931: Yes), the memory controller 200 reads the address translation information from the nonvolatile memory 300 and transfers the address translation information to the host computer 100. The memory controller 200 supplies a status denoting the execution result of the initialization command to the host computer 100 (step S932).

The memory controller 200 determines whether or not the initialization command for reading the access frequency information is received (step S933). If the initialization command for reading of the access frequency information is not received (step S933: No), the memory controller 200 returns to step S933. On the other hand, if the initialization command is received (step S933: Yes), the memory controller 200 acquires the access frequency information from the nonvolatile memory 300 and transfers the access frequency information to the RAM 230. The memory controller 200 performs weighting in which the access number of each of the address translation information pages is multiplied by a predetermined coefficient (for example, 0.5), and writes the value back to the RAM 230. The memory controller 200 supplies a status denoting the execution result of the initialization command to the host computer 100 (step S934).

The memory controller 200 determines whether or not the initialization command for reading the free physical address information is received (step S935). If the initialization command for reading of the free physical address information is not received (step S935: No), the memory controller 200 returns to step S935. On the other hand, if the initialization command is received (step S935: Yes), the memory controller 200 acquires and holds the free physical address information from the nonvolatile memory 300. The memory controller 200 supplies a status denoting the execution result of the initialization command to the host computer 100 (step S936).

The memory controller 200 determines whether or not the initialization command for reading a portion of the address translation information is received (step S937). If the initialization command for reading of a portion of the address translation information is not received (step S937: No), the memory controller 200 returns to step S937. On the other hand, if the initialization command is received (step S937: Yes), the memory controller 200 acquires and holds a portion (for example, 32 pages) of the address translation information from the nonvolatile memory 300 on the basis of the access frequency (step S938).

Specifically, in step S938, the memory controller 200 looks up the access frequency information, and acquires the page number of each address translation information page of the 32 pages with the highest access frequencies. The page numbers of these will be referred to as Ki (where i is an integer of 1 to K32).

The data transfer unit 224 acquires a physical page address Pi to be read using the following equation, and issues a read request specifying the physical page address.

Pi=P0+(page size)×Ki Equation 2

In the above equation, P0 is the leading physical page address in the address translation information holding region 322 in the nonvolatile memory 300. The page size is the data size of the address translation information page, which is 4,096 (bytes).

The memory controller 200 holds the 32 pages of the address translation information that are read in the address translation information holding region 231 in the memory controller 200.

The memory controller 200 supplies a status denoting the execution result of the initialization command to the host computer 100 (step S938). After step S938, the memory controller 200 ends the controller-side initialization process.

Note that, a configuration is adopted in which the memory controller 200 performs the controller-side initialization process according to the initialization command from the host computer 100; however the present disclosure is not limited to this configuration. For example, the memory controller 200 may spontaneously perform the controller-side initialization process without the host computer 100 issuing an initialization command in the host-side initialization process.

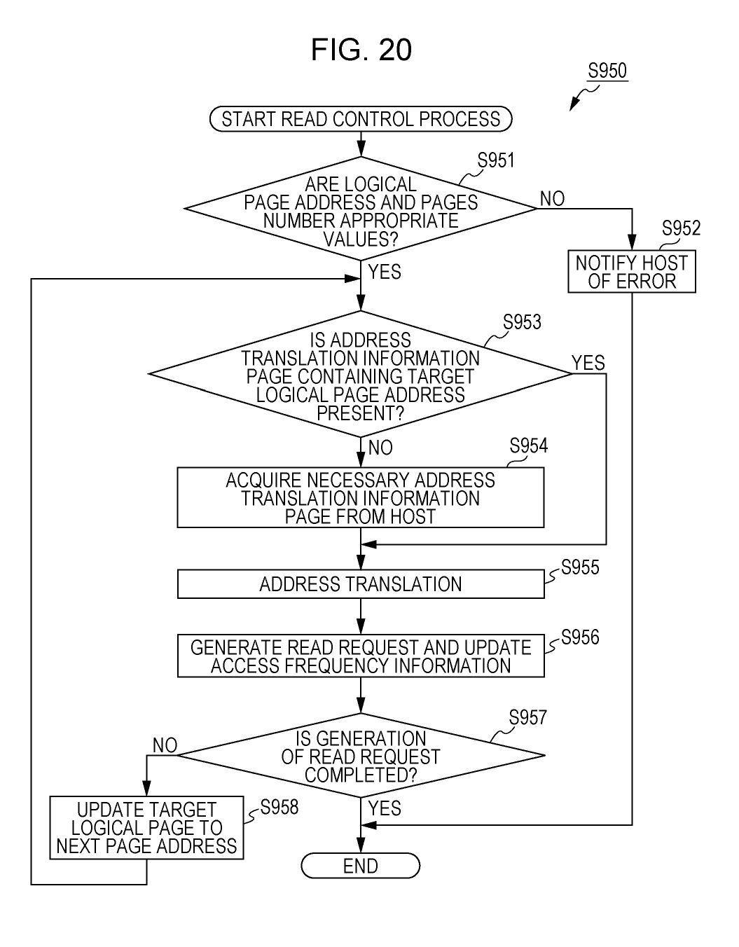

FIG. 20 is a flowchart showing an example of the read control process in the first embodiment. The memory controller 200 determines whether or not the logical page address and the transfer pages number that are specified by the read command are appropriate values (step S951).

Specifically, in the following three cases, either the logical page address or the transfer pages number is determined not to be an appropriate value. First, when the reading start page address or the writing start page address that is specified is not an address in the logical page address space that is defined in advance, the logical page address is determined not to be an appropriate value. For example, a logical page address outside of the range of 0x00000 to 0x07bfff, or the like.

When the transfer pages number is greater than the total number of pages in the logical page address space (507,904), the transfer pages number is determined not to be an appropriate value. Note that a configuration may be adopted in which an upper limit value that is smaller than the total number of pages of the logical page address space (for example, 256) is set in advance, and when the transfer pages number is greater than the upper limit value, the transfer pages number is determined not to be an appropriate value.

When an address in which the transfer pages number is added to the specified logical page address, does not correspond to an address in the logical page address space that is defined, the logical page address and the transfer pages number that are specified are determined not to be appropriate values.

When the logical page address and the transfer pages number that are specified are not appropriate values (step S951: No), the memory controller 200 generates a status denoting the error and notifies the host computer 100 with the status (step S952).

On the other hand, when the logical page address and the transfer pages number that are specified are appropriate values (step S951: Yes), the memory controller 200 acquires the page number of the address translation information page containing the target logical page address of the target to be read. The memory controller 200 determines whether or not the address translation information page of the page number is in the address translation information that is held (step S953). Here, the reading start page address is first set to the target logical page address.

If there is no corresponding address translation information page (step S953: No), the memory controller 200 acquires the address translation information page from the host computer 100 using a page acquisition request (step S954).

If there is a corresponding address translation information page (step S953: Yes), or after step S954, the memory controller 200 translates the logical page address that is specified into a physical page address (step S955).

The memory controller 200 generates a read request specifying the physical page address, and adds the request to a queue. The memory controller 200 updates the access frequency information. Specifically, the access number of the address translation information page containing the target logical page address is increased by a predetermined value (for example, “1”) (step S956).

The memory controller 200 determines whether or not the generation of the read request for reading the specified page number is completed (step S957). If the generation of the read request is not completed (step S957: No), the memory controller 200 updates the target logical page address to the page address following the present target logical page address. For example, when the present target logical page address is 0x013ff, the target logical page address is updated to 0x01400, which is the sum of 0x013ff and 0x00001 (step S958). After step S958, the memory controller 200 returns to step S953.

When the generation of the read request is completed (step S957: Yes), or after step S952, the memory controller 200 ends the read control process.

Note that, a configuration is adopted in which the memory controller 200 performs the process of determining whether or not the logical page address and the transfer pages number are appropriate values; however, a configuration may be adopted in which the host computer 100 performs the process instead of the memory controller 200.

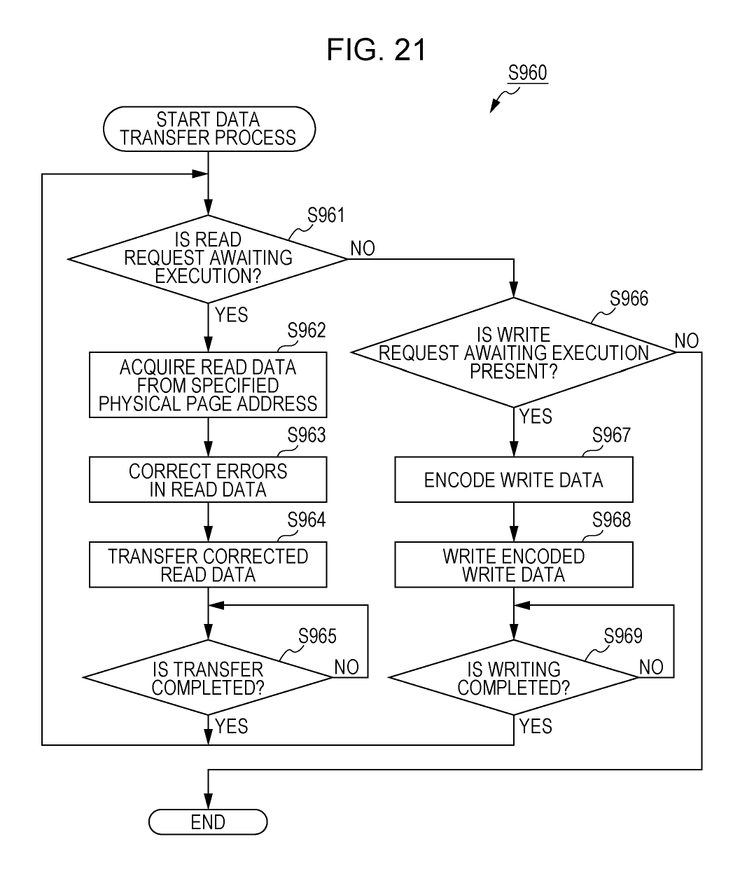

FIG. 21 is a flowchart showing an example of the data transfer process in the first embodiment. The memory controller 200 determines whether or not a read request is awaiting execution in the request queue (step S961).

When a read request is awaiting execution (step S961: Yes), the memory controller 200 extracts the read request from the queue and supplies the read request to the nonvolatile memory 300. The memory controller 200 acquires the read data from the physical page address that is specified from the nonvolatile memory 300 (step S962).

The memory controller 200 performs detection and correction of errors in the read data on the basis of the ECC (step S963). The memory controller 200 transfers the corrected read data together with the status to the host computer 100. However, when the correction fails, the memory controller 200 generates a status denoting an error and supplies the status to the host computer 100 (step S964).

The memory controller 200 determines whether or not the transfer of the read data or the status is completed (step S965). If the transfer is not completed (step S965: No), the memory controller 200 returns to step S965. On the other hand, if the transfer is completed (step S965: Yes), the memory controller 200 returns to step S961.

When a read request is not awaiting execution (step S961: No), the memory controller 200 determines whether or not a write request is awaiting execution in the request queue (step S966). When a write request is awaiting execution (step S966: Yes), the memory controller 200 extracts the write request from the queue and supplies the write request to the nonvolatile memory 300.

The memory controller 200 encodes the write data into an ECC (step S967). The memory controller 200 supplies the encoded write data together with the write request to the nonvolatile memory 300, and writes the write data. Here, when the nonvolatile memory 300 fails at writing, the memory controller 200 generates a status denoting an error and supplies the status to the host computer 100 (step S968).

The memory controller 200 determines whether or not the writing of the write data is completed (step S969). If the writing is not completed (step S969: No), the memory controller 200 returns to step S969-1. On the other hand, if the writing is completed (step S969: Yes), the memory controller 200 returns to step S961.

When a write request is not awaiting execution (step S966: No), the memory controller 200 ends the data transfer process.

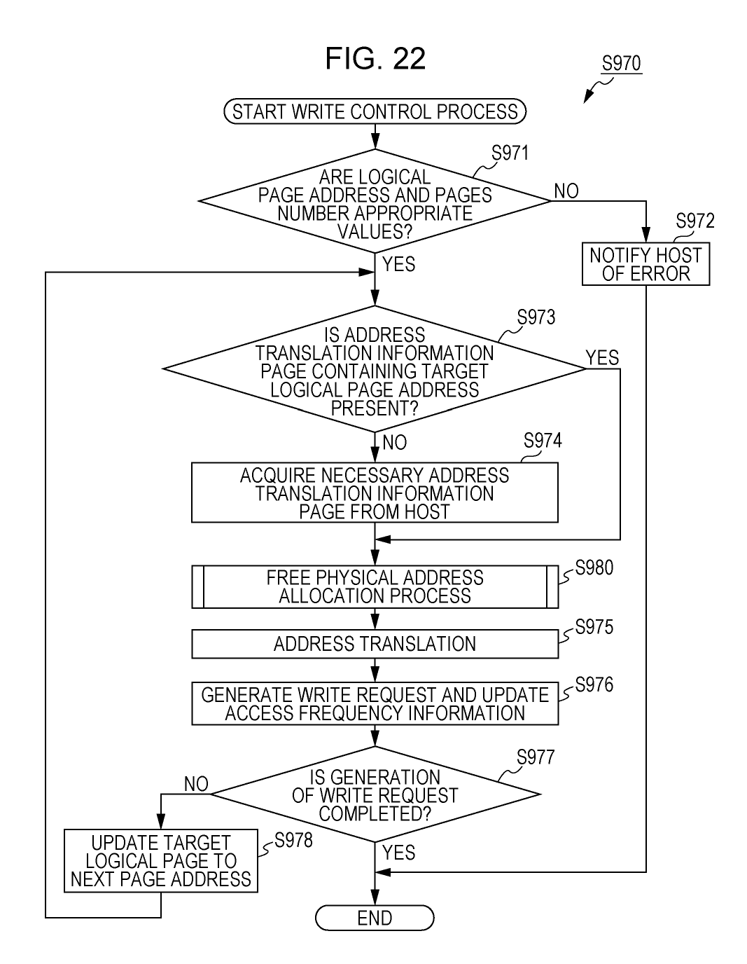

FIG. 22 is a flowchart showing an example of a write control process in the first embodiment. The memory controller 200 determines whether or not the logical page address and the transfer pages number that are specified by the write command are appropriate values (step S971).

When the logical page address and the transfer pages number that are specified are not appropriate values (step S971: No), the memory controller 200 generates a status denoting the error and notifies the host computer 100 with the status (step S972).

On the other hand, when the logical page address and the transfer pages number that are specified are appropriate values (step S971: Yes), the memory controller 200 acquires the page number of the address translation information page containing the target logical page address of the target to be read. The memory controller 200 determines whether or not the address translation information page of the page number is in the address translation information that is held (step S973). Here, the reading start page address is first set to the target logical page address.

If there is no corresponding address translation information page (step S973: No), the memory controller 200 acquires the address translation information page from the host computer 100 using a page acquisition request (step S974).

If there is a corresponding address translation information page (step S973: Yes), or after step S974, the memory controller 200 performs the free physical address allocation process (step S980). The memory controller 200 translates the logical page address that is specified into a physical page address on the basis of the address translation information page (step S975).

The memory controller 200 generates a write request specifying the physical page address, and adds the request to the queue. The memory controller 200 updates the access frequency information (step S976).

The memory controller 200 determines whether or not the generation of the write request for writing the specified page number is completed (step S977). If the generation of the write request is not completed (step S977: No), the memory controller 200 updates the target logical page address to the page address following the present target logical page address (step S978). After step S978, the memory controller 200 returns to step S973.

When the generation of the write request is completed (step S977: Yes), or after step S972, the memory controller 200 ends the write control process.

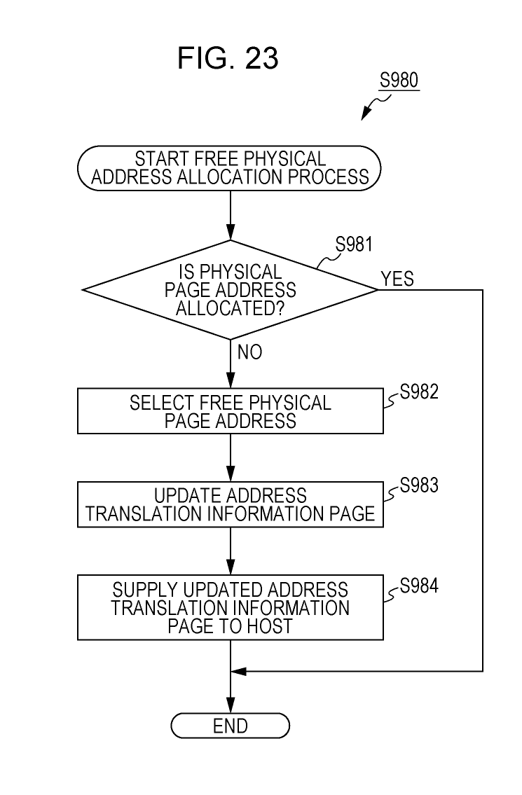

FIG. 23 is a flowchart showing an example of the free physical address allocation process in the first embodiment. The memory controller 200 looks up the entries corresponding to the logical page address that is specified, and determines whether or not a physical page address is allocated to the logical page address (step S981).

When the physical page address is not allocated (step S981: No), the memory controller 200 looks up the free physical address information, and selects one of the free physical page addresses. The memory controller 200 updates the usage state of the physical page address that is selected in the free physical address information to “in use” (step S982). The memory controller 200 allocates the physical page address that is selected to the logical page address that is specified. Specifically, the memory controller 200 updates the physical page address in the entry relating to the logical page address that is specified using the physical page address that is selected. The memory controller 200 updates the allocation state of the entry to “allocated” (step S983). The memory controller 200 supplies the updated address translation information page to the host computer 100 (step S984).

When the physical page address is allocated (step S981: Yes), or after step S984, the memory controller 200 ends the free physical address allocation process.

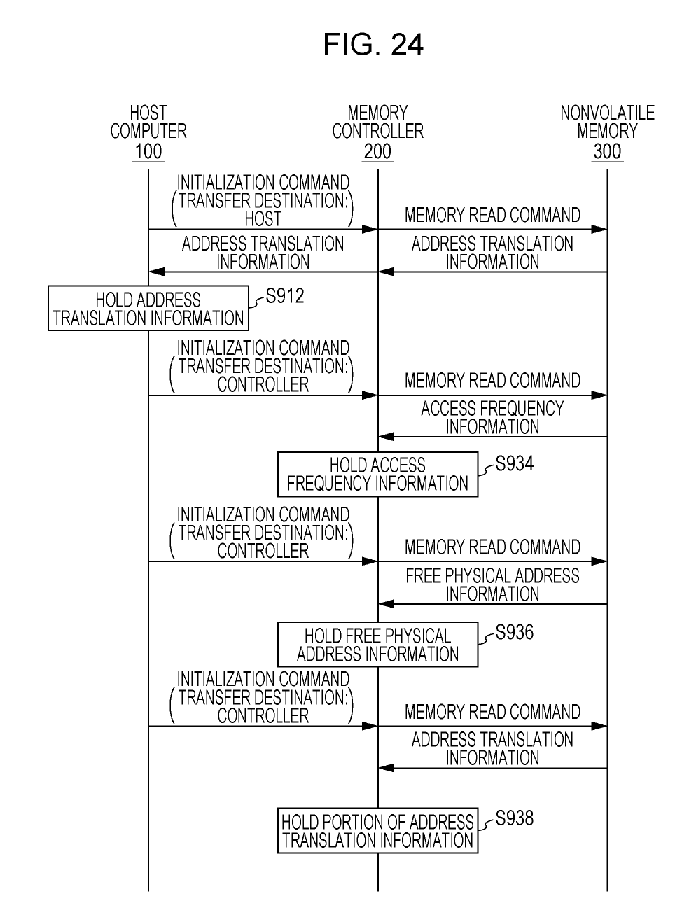

FIG. 24 is an example of a sequence diagram showing operations of the information processing system during initialization in the first embodiment. First, the host computer 100 specifies an address of the address translation information holding region 322, issues an initialization command in which the transfer destination is set to the host computer 100, and supplies the initialization command to the memory controller 200. The memory controller 200 reads all the address translation information from the nonvolatile memory 300 according to the initialization command, and transfers the address translation information to the host computer 100. The host computer 100 holds the address translation information that is transferred thereto (step S912).

The host computer 100 specifies an address of the access frequency information holding region 323, issues an initialization command in which the transfer destination is set to the memory controller 200, and supplies the initialization command to the memory controller 200. The memory controller 200 reads and holds the access frequency information from the nonvolatile memory 300 according to the initialization command (step S934).

The host computer 100 specifies an address of the free physical address information holding region 324, issues an initialization command in which the transfer destination is set to the memory controller 200, and supplies the initialization command to the memory controller 200. The memory controller 200 reads and holds the free physical address information from the nonvolatile memory 300 according to the initialization command (step S936).

The host computer 100 specifies an address of the address translation information holding region 322, issues an initialization command in which the transfer destination is set to the memory controller 200, and supplies the initialization command to the memory controller 200. The memory controller 200 reads and holds a portion of the address translation information from the nonvolatile memory 300 according to the initialization command (step S938).

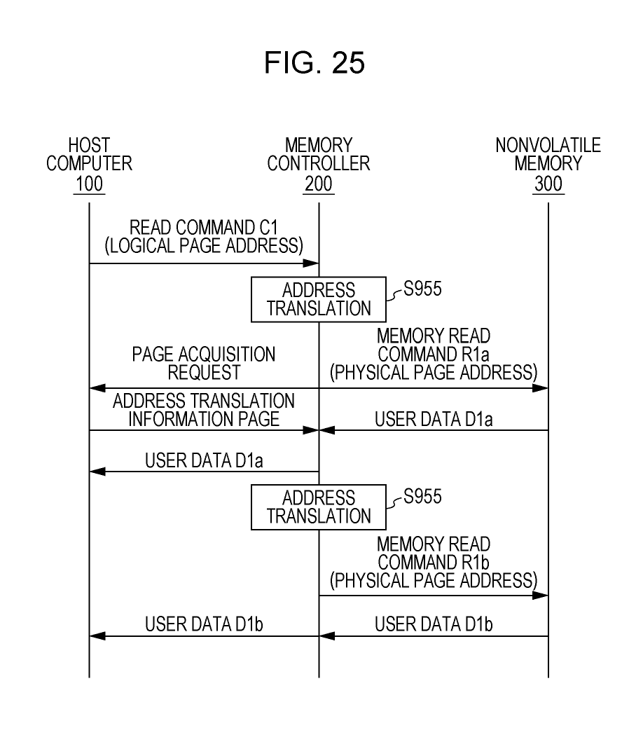

FIG. 25 is an example of a sequence diagram showing operations of the information processing system during reading of user data in the first embodiment. A read command C1 with a transfer pages number of 2 pages is issued, and the read command C1 is divided into memory read commands R1a and R1b. It will be assumed that an entry corresponding to a logical page address L1a of the first page of the read command C1 is held in the memory controller 200, and an entry corresponding to a logical page address L1b of the second page is not held in the memory controller 200.

The host computer 100 issues the read command C1 and supplies the read command C1 to the memory controller 200. The memory controller 200 looks up the entry corresponding to the logical page address L1a of the first page of the read command C1, and translates the logical page address L1a into a physical page address P1a (step S955). The memory controller 200 generates a memory read command R1a that specifies the physical page address P1a, and supplies the memory read command to the nonvolatile memory 300. The memory controller 200 acquires user data D1a that is read from the physical page address P1a from the nonvolatile memory 300, and transfers the user data D1a to the host computer 100.

Since the memory controller 200 is not holding the entry corresponding to the logical page address L1b of the second page, the memory controller 200 requests the address translation information page containing the entry from the host computer 100 using a page acquisition request. During the reading of the user data D1a or the like, the memory controller 200 acquires the requested address translation information page from the host computer 100. Specifically, the acquisition of the address translation information is performed at the same time as one of the reading of user data D1a from the nonvolatile memory 300 (step S962), the error correction (step S963), or the transfer of the user data D1a to the host (step S964), or a plurality of processes. The memory controller 200 translates the logical page address L1b into a physical page address P1b on the basis of the address translation information page (step S955). The memory controller 200 generates a memory read command R1b that specifies the physical page address P1b, and supplies the memory read command to the nonvolatile memory 300. The memory controller 200 acquires user data D1b that is read from the physical page address P1b from the nonvolatile memory 300, and transfers the user data D1b to the host computer 100.

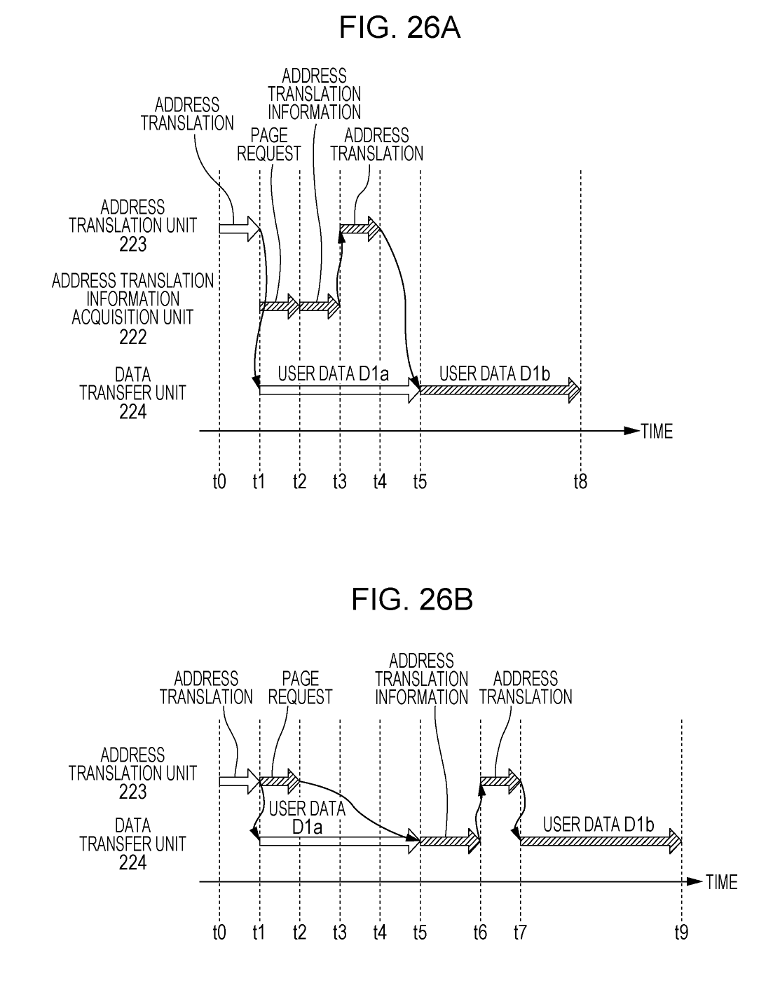

FIGS. 26A and 26B are examples of timing charts showing the operations of the memory controller during reading in the first embodiment. A read command C1 with a transfer pages number of 2 pages is issued, and the read command C1 is divided into memory read commands R1a and R1b. It will be assumed that an entry corresponding to a logical page address L1a of the first page of the read command C1 is held in the memory controller 200, and an entry corresponding to a logical page address L1b of the second page is not held in the memory controller 200.

FIG. 26A is a timing chart in the first embodiment in which the address translation information page is acquired from the host computer 100. At time t0, the address translation unit 223 looks up the entry corresponding to the logical page address L1a of the first page of the read command C1, and translates the logical page address L1a into a physical page address P1b.

In the period until time t1, the data transfer unit 224 issues the memory read command R1a that specifies the translated physical page address P1a. In the period from time t1 to time t2, the address translation information acquisition unit 222 requests the address translation information page corresponding to the logical page address L1b of the second page of the read command C1 from the host computer 100.

At time t1, the data transfer unit 224 starts transferring the user data D1a that is read from the physical page address P1a.

In the period from time t2 to time t3, the address translation information acquisition unit 222 acquires the address translation information page corresponding to the logical page address L1b of the second page from the host computer 100.

In the period from time t3 to time t4, the address translation unit 223 looks up the acquired address translation information page, and translates the logical page address L1b into the physical page address P1b. The data transfer unit 224 issues the memory read command R1b that specifies the physical page address P1b.

At time t5, when the transfer of the user data D1a is completed, the data transfer unit 224 starts transferring the user data D1b that is read from the physical page address P1b. At time t8 after time t5, the transfer of the user data D1b is completed.

FIG. 26B is a timing chart in a comparative example a configuration is assumed in which the address translation information page is acquired from the nonvolatile memory. At time t0, the address translation unit 223 looks up the entry corresponding to the logical page address L1a of the first page of the read command C1, and translates the logical page address L1a into a physical page address P1a.

In the period until time t1, the data transfer unit 224 issues the memory read command R1a that specifies the translated physical page address P1a. In the period from time t1 to time t2, the address translation unit 223 acquires the address translation information page corresponding to the logical page address L1b of the second page from the nonvolatile memory 300.

At time t1, the data transfer unit 224 starts transferring the user data D1a that is read from the physical page address P1a.

At time t5, when the transfer of the user data D1a is completed, in the period from time t5 to time t6, the address translation unit 223 acquires the address translation information page corresponding to the logical page address L1b from the nonvolatile memory 300.

Note that, the data transfer rate between the host computer 100 and the memory controller 200 is often faster than the data transfer rate between the nonvolatile memory 300 and the memory controller 200. Therefore, the time taken to acquire the address translation information from the nonvolatile memory 300 (=t6−t5) is often longer than the time taken to acquire the address translation information from the host computer 100 (=t3−t2).

In the period from time t6 to time t7, the address translation unit 223 looks up the acquired address translation information page, and translates the logical page address L1b into the physical page address P1b. The data transfer unit 224 issues the memory read command that specifies the physical page address P1b.

At time t7, the data transfer unit 224 starts transferring the user data D1a that is read from the physical page address P1b. At time t9 after times t7 and t8, the transfer of the user data D1b is completed.

FIG. 26A of the case in which the address translation information is acquired from the host computer 100 will be compared with FIG. 26B of the case in which the address translation information is acquired from the nonvolatile memory 300. In the prior case, the reading of the user data from the nonvolatile memory 300 and the acquisition of the address translation information from the host computer 100 can be executed in parallel. Therefore, during the transfer of the user data D1a, the memory controller 200 can acquire the necessary address translation information page for the transfer of the next user data D1b. Therefore, at time t5 at which the transfer of the user data D1a is completed, the memory controller 200 can start transferring the user data D1b.

In contrast, in the later case, since the address translation information is read from the nonvolatile memory 300, the reading of the address translation information and the reading of the user data may not be executed in parallel. Therefore, the memory controller 200 may not start the transfer of the address translation information until time t5, after the transfer of the user data D1a is completed. The memory controller 200 may not start the transfer of the next user data D1b until time t6, after the transfer of the address translation information is completed. In other words, the transfer of the user data D1b is delayed by the amount of time taken to transfer the address translation information.

Therefore, by acquiring the address translation information from the host computer 100 as exemplified in FIG. 26A, the delay in the transfer of the user data D2 due to the transfer of the address translation information is suppressed as exemplified in FIG. 26B. As a result, the transfer time of the data is shortened.

In this manner, according to the first embodiment of the present disclosure, since the memory controller 200 acquires the entry from the host computer 100, it is possible to perform the acquisition of an entry and the transfer of transfer data in parallel. Accordingly, it is possible to reduce the time taken to transfer the transfer data by suppressing the delay caused by the acquisition of an entry.

### 2. Second Embodiment

### Configuration Example of Host Computer

In the first embodiment, the memory controller 200 performs the address translation regardless of the data size (the transfer pages number) of the transfer data. However, when the transfer pages number that is specified by the transfer command is relatively small, there is a concern that the memory controller 200 may not perform the transfer of an entry and the transfer of the transfer data in parallel. For example, consideration is given to a case in which, after the transfer of the user data D1 according to the read command C1 with a transfer pages number of “1” is completed, the read command C2 with a transfer pages number of “1” is issued. In this case, since the transfer of the user data D1 is completed, the memory controller 200 may not execute the transfer of the entry corresponding to the read command C2 and the transfer of the user data D1 in parallel. Therefore, the transfer time of the transfer data may not be reduced.

The information processing system of the second embodiment differs from the first embodiment in that, when the transfer pages number is relatively small, the host computer 100 performs the address translation instead of the memory controller 200.

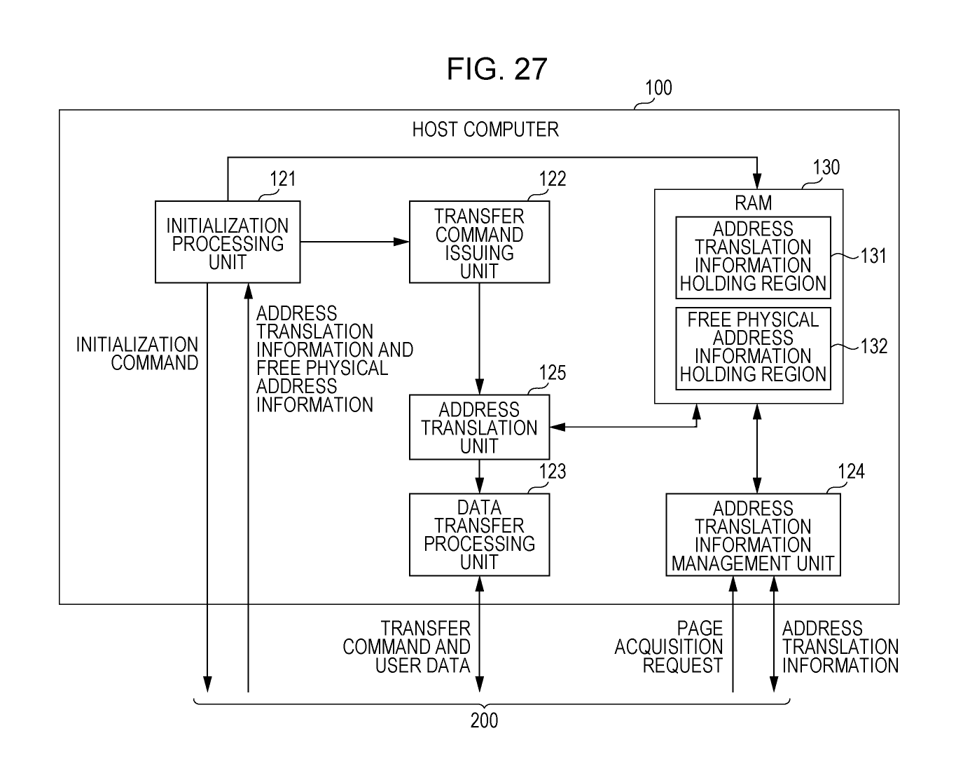

FIG. 27 is a block diagram showing a configuration example of the host computer 100 in the second embodiment. The host computer 100 of the second embodiment differs from that of the first embodiment in that an address translation unit 125 is further provided. The host computer 100 of the second embodiment differs from that of the first embodiment in that a free physical address information holding region 132 is further provided in the RAM 130.

In the initialization process, the initialization processing unit 121 of the second embodiment further issues a read command for reading the free physical address information. The transfer destination of the read command is set to the host computer 100. The initialization processing unit 121 acquires the free physical address information from the memory controller 200, and causes the free physical address information holding region 132 to hold the free physical address information.

The address translation unit 125 determines whether or not the transfer pages number specified by the transfer command is less than a predetermined value (for example, “2”). When the transfer pages number is less than the predetermined value, the address translation unit 125 looks up the address translation information and the free physical address information, and translates the specified logical page address into a physical page address. The address translation unit 125 adds a translated flag that is set to “on” and the translated physical page address to the transfer command, and supplies the transfer command to the data transfer processing unit 123. The translated flag is a flag indicating whether or not the host computer 100 performed the address translation. For example, the translated flag is set to “on” when the host computer 100 performed the address translation, and off when this is not the case.

On the other hand, when the transfer pages number is the predetermined value or greater, the address translation unit 125 adds the translated flag that is set to “off” to the transfer command, and supplies the transfer command to the data transfer processing unit 123 without performing the address translation.

When the address translation information management unit 124 of the second embodiment receives the updated address translation information page, the address translation information management unit 124 also updates the free physical address information as necessary.

On receiving the transfer command with the translated flag set to “on”, the memory controller 200 updates the address translation information and the free physical address information in the RAM 230 using the logical page address and the physical page address specified by the command. Accordingly, integrity is secured between the address translation information and the free physical address information which are held by the host computer 100 and the memory controller 200, respectively.

Note that, the memory controller 200 updates the address translation information and the free physical address information held therein using a transfer command with the translated flag set to “on”; however, the present disclosure is not limited to this configuration. For example, a configuration may be adopted in which the address translation information management unit 124 within the host computer 100 supplies the memory controller 200 with a notification indicating the logical page address and the physical page address related to the update, separately from the transfer command. In this case, the memory controller 200 updates the address translation information and the free physical address information held therein on the basis of the addresses in the notification.

The address translation information management unit 124 may supply the memory controller 200 with a notification indicating the address translation information page and the free physical address information page that are updated, separately from the transfer command. In this case, the memory controller 200 updates the address translation information and the free physical address information held therein on the basis of the pages in the notification.

When the address translation unit 125 within the host computer 100 determines whether or not it is necessary to allocate a new physical page address in the address translation, the address translation unit 125 may change to a process in which the memory controller 200 is caused to perform the address translation. Specifically, the address translation unit 125 performs the address translation when the transfer pages number is less than the predetermined value, and the logical page address is allocated to a physical page address. On the other hand, when the transfer pages number is the predetermined value or greater, or a physical page address is not allocated to the logical page address, the host computer 100 supplies a transfer command with the translated flag set to “off” without performing the address translation. In this configuration, it is not necessary for the host computer 100 to hold the free physical address information.

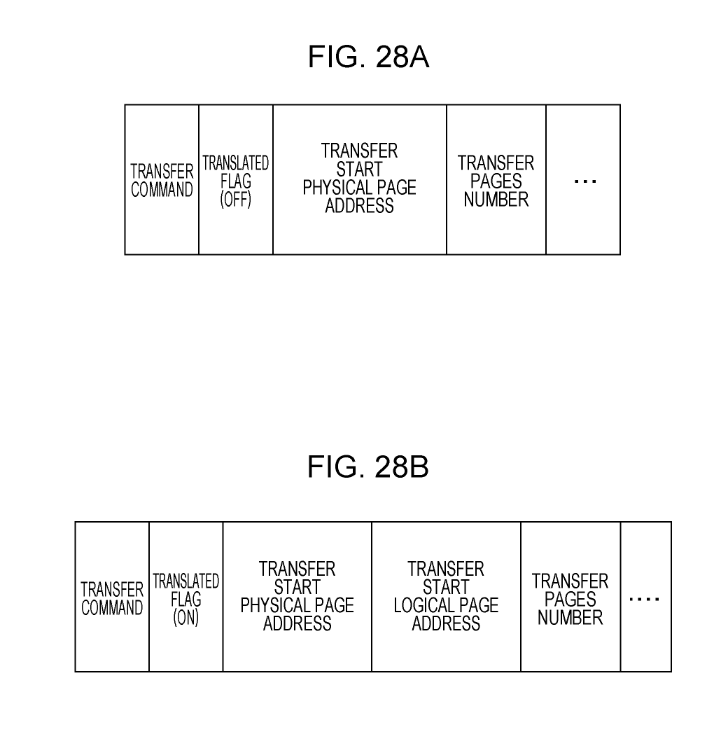

FIGS. 28A and 28B are diagrams showing an example of the data configuration of transfer commands in the second embodiment. FIG. 28A is an example of a transfer command when the transfer pages number is the predetermined value or greater. In this case, since the host computer 100 does not perform the address translation, the translated flag that is set to “off” is added to the transfer command.

FIG. 28B is an example of a transfer command when the transfer pages number is less than the predetermined value. In this case, since the host computer 100 performs the address translation, the translated flag that is set to “on” and the translated physical page address are added to the transfer command. The pre-translation logical page address is not deleted from the transfer command, and is sent together with the physical page address to the memory controller 200. The logical page address is used to update the access frequency. Note that, in FIGS. 28A and 28B, the transfer source address and the transfer destination address are omitted.

When the translated flag is set to “on”, the memory controller 200 of the second embodiment generates a transfer request specifying the added physical page address without performing the address translation. On the other hand, when the translated flag is set to “off”, the memory controller 200 performs the address translation and generates a transfer request in the same manner as in the first embodiment.

Note that, a configuration is adopted in which, when the transfer pages number is less than the predetermined value, the host computer 100 supplies the logical page address together with the physical page address to the memory controller 200; however, a configuration may also be employed in which only the physical page address is supplied. In this case, the memory controller 200 does not update the access frequency when the host computer 100 performs the address translation.

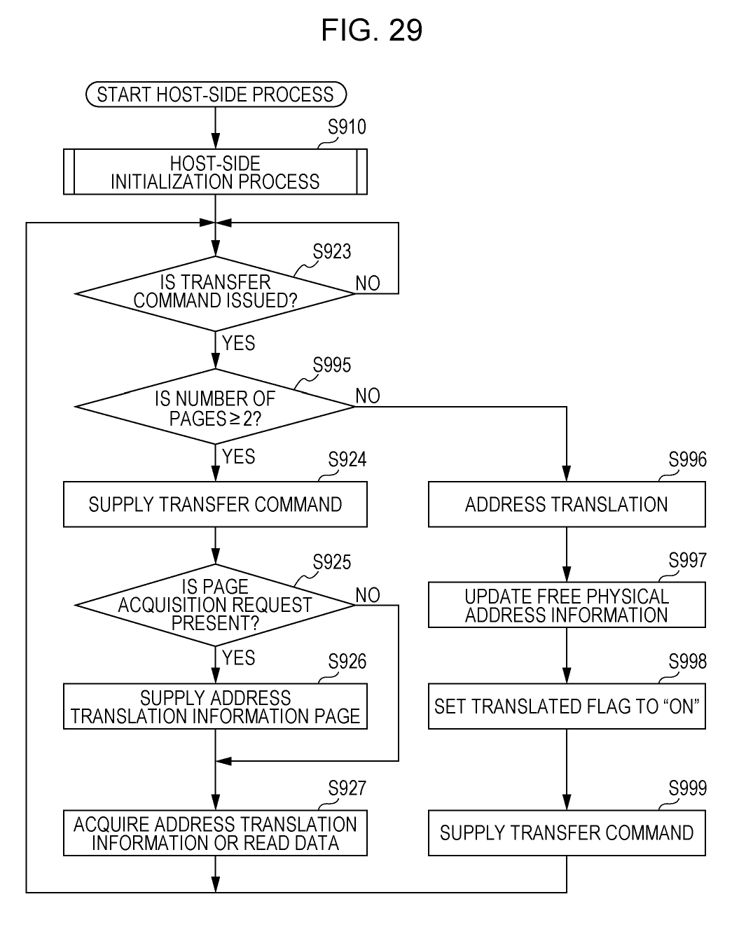

FIG. 29 is a flowchart showing an example of the host-side process in the second embodiment. The host-side process of the second embodiment differs from that of the first embodiment in that steps S995 to S999 are further executed.

When the transfer command is issued (step S923: Yes), the host computer 100 determines whether or not the transfer pages number specified by the transfer command is 2 pages or more (step S995). When the transfer pages number is 2 pages or more (step S995: Yes), the host computer 100 supplies a transfer command, to which the translated flag that is set to “off” is added, to the memory controller 200 (step S924). The host computer 100 executes steps S925 to S927.

When the transfer pages number is less than 2 pages (step S995: No), the host computer 100 translates the logical page address into a physical page address (step S996). When the host computer 100 newly allocates a free physical page address in the address translation, the host computer 100 updates the free physical address information (step S997).

The host computer 100 sets the translated flag to “on” (step S998). The host computer 100 adds the translated flag and the physical page address to the transfer command and supplies the transfer command to the memory controller 200 (step S999). The process returns to step S923.

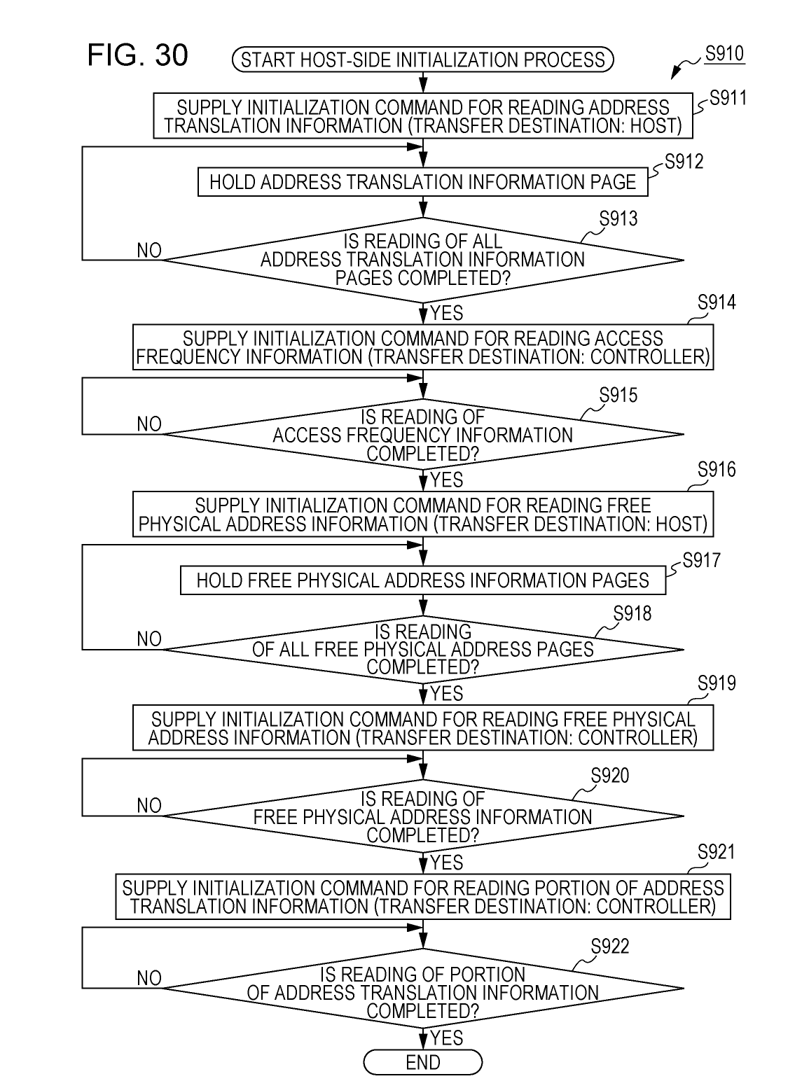

FIG. 30 is a flowchart showing an example of the host-side initialization process in the second embodiment. The host-side initialization process of the second embodiment differs from that of the first embodiment in that steps S916 to S918 are further executed.

When the reading of the access frequency information is completed (step S915: Yes), the host computer 100 issues an initialization command for reading the free physical address information. In the initialization command, the transfer destination of free physical address information, which is the read data, is set to the host computer 100. The host computer 100 supplies the initialization command to the memory controller 200 (step S916).

The host computer 100 holds the free physical address information page that is read (step S917). The host computer 100 determines whether or not the reading of all (32 pages) of the free physical address information pages is completed on the basis of the status from the memory controller 200 (step S918). If the reading of all the pages is not completed (step S918: No), the host computer 100 returns to step S917.

If the reading of the free physical address information is completed (step S918: Yes), the host computer 100 executes steps S919 to S922.

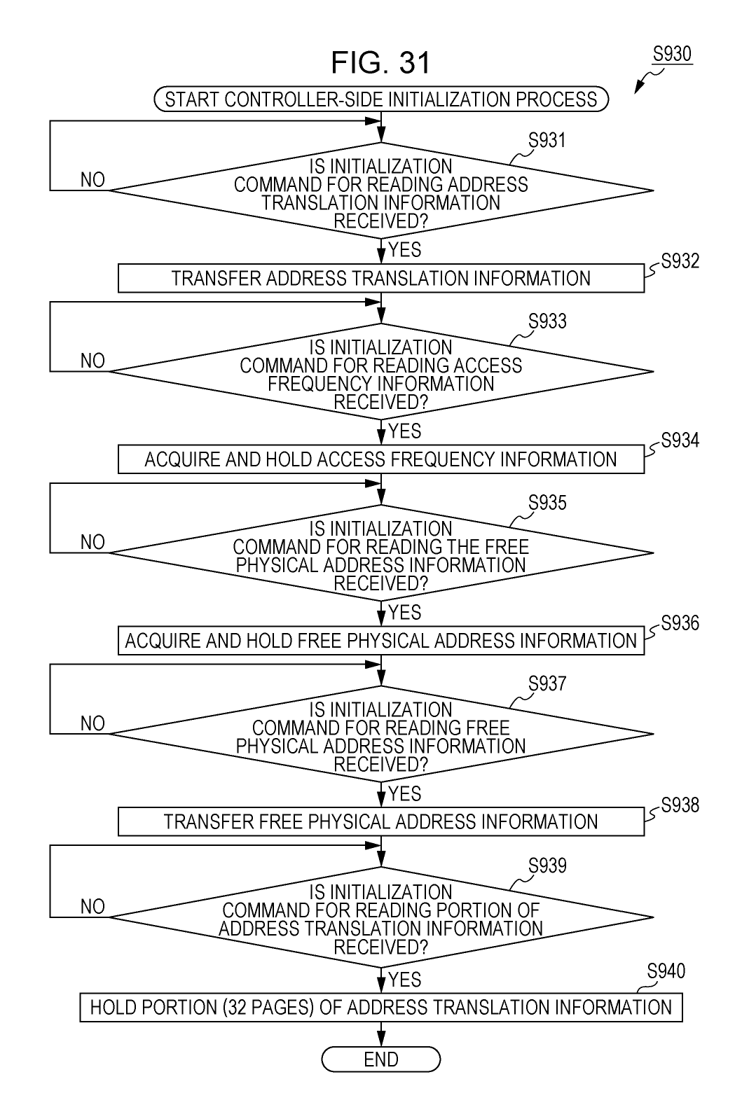

FIG. 31 is a flowchart showing an example of the controller-side initialization process in the second embodiment. The controller-side initialization process of the second embodiment differs from that of the first embodiment in that steps S937 to S938 are further executed.

Note that, as shown in FIGS. 30 and 31, a configuration is adopted in which the memory controller 200 transfers and holds the free physical address information according to two initialization commands with different transfer destinations; however the present disclosure is not limited to this configuration. A configuration may be adopted in which the host computer 100 issues one initialization command, and the memory controller 200 holds the free physical address information, and transfers the free physical address information to the host computer 100 according to the initialization command.

When the memory controller 200 holds the free physical address information (step S936), the memory controller 200 determines whether or not the initialization command for reading the free physical address information is received (step S937). If the initialization command for reading of the free physical address information is not received (step S937: No), the memory controller 200 returns to step S937. If the initialization command is received (step S937: Yes), the memory controller 200 reads the free physical address information from the nonvolatile memory 300 and transfers the free physical address information to the host computer 100 (step S938). After step S938, the memory controller 200 executes steps S939 and S940.

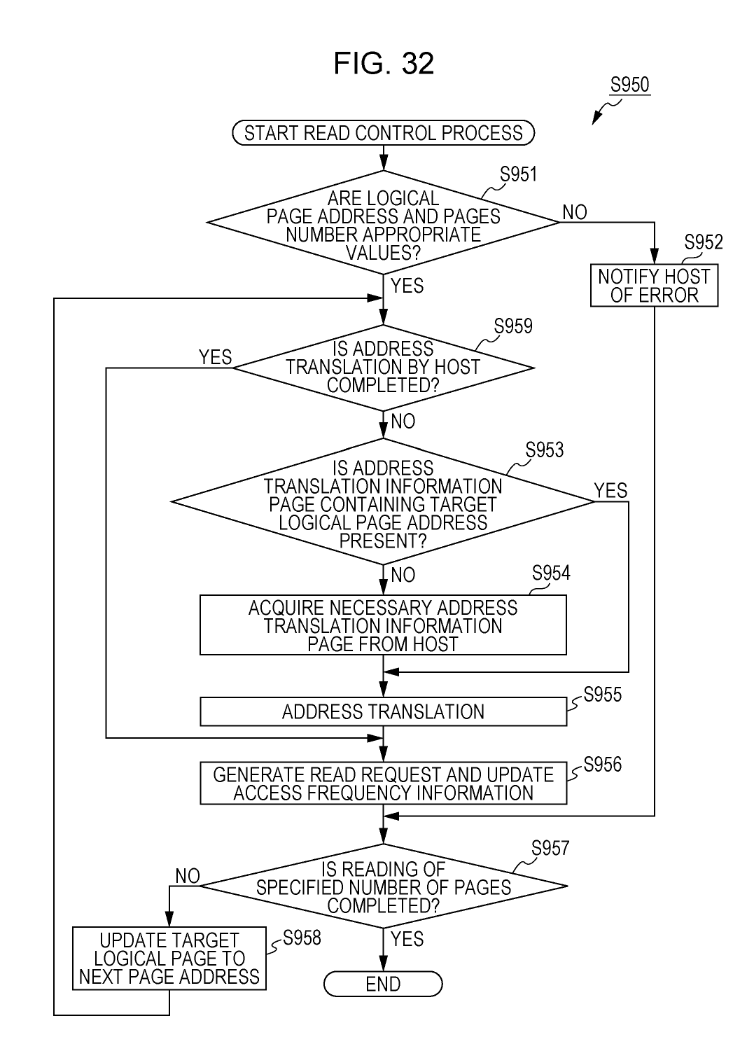

FIG. 32 is a flowchart showing an example of the read control process in the second embodiment. The read control process of the second embodiment differs from that of the first embodiment in that step S959 is further executed.

The memory controller 200 determines whether or not the logical page address and the transfer pages number that are specified are appropriate values (step S951). However, when the translated flag is “on”, since the transfer pages number is “1”, the memory controller 200 may determine whether or not only the logical page address is an appropriate value.

When the logical page address and the transfer pages number that are specified are appropriate values (step S951: Yes), the memory controller 200 looks up the translated flag. The memory controller 200 determines whether or not the logical page address is translated by the host computer 100 (step S959). When the logical page address is not translated (step S959: No), the memory controller 200 executes steps S953 to S955. When the logical page address is translated (step S959: Yes), or after step S955, the memory controller 200 generates a read request that specifies the translated physical page address. The memory controller 200 also updates the access frequency of the logical page address that is specified by the transfer command (step S956). The memory controller 200 executes the processes of steps S957 onward.

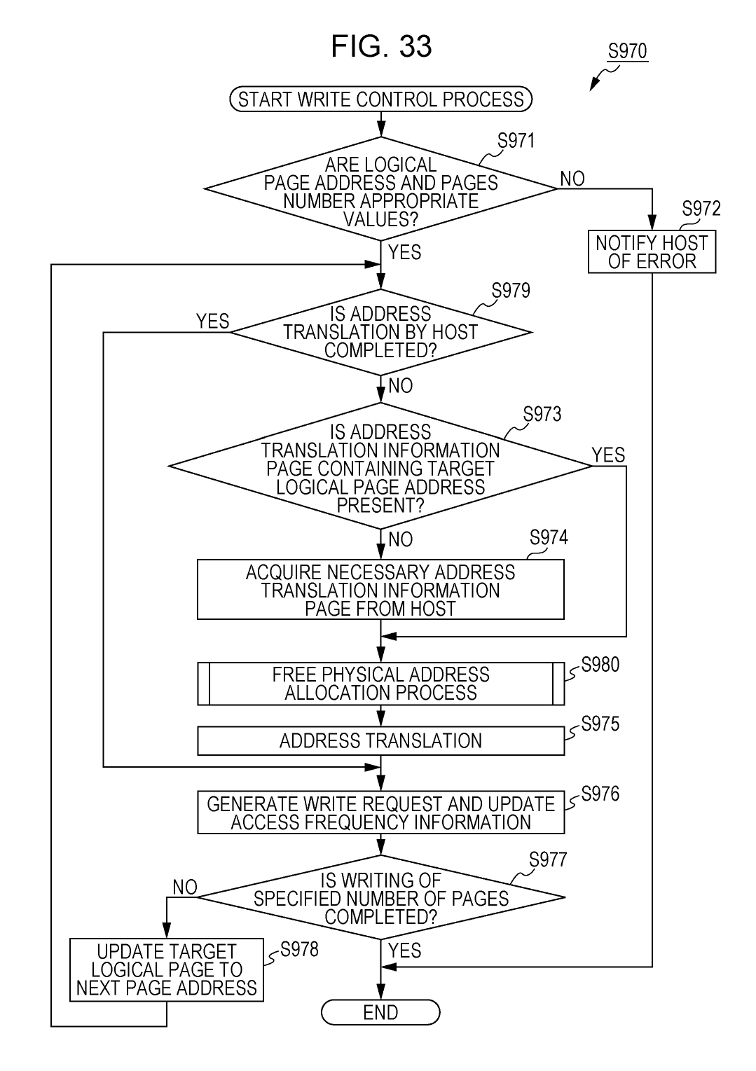

FIG. 33 is a flowchart showing an example of the write control process in the second embodiment. The write control process of the second embodiment differs from that of the first embodiment in that step S979 is further executed.

When the logical page address and the transfer pages number that are specified are appropriate values (step S971: Yes), the memory controller 200 looks up the translated flag. The memory controller 200 determines whether or not the logical page address is translated by the host computer 100 (step S979). When the logical page address is not translated (step S979: No), the memory controller 200 executes steps S973 to S975. On the other hand, when the logical page address is translated (step S979: Yes), or after step S975, the memory controller 200 generates a write request that specifies the translated physical page address. The memory controller 200 also updates the access frequency of the logical page address that is specified by the transfer command (step S976). The memory controller 200 executes the processes of steps S977 onward.

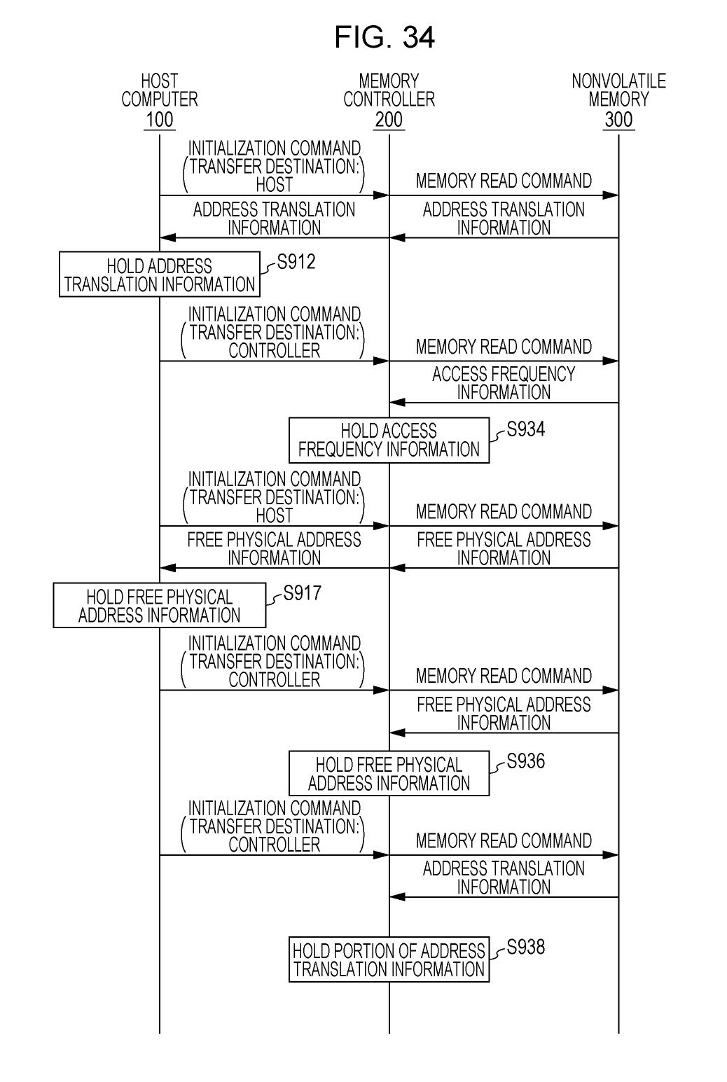

FIG. 34 is an example of a sequence diagram showing operations of the information processing system during initialization in the second embodiment. The host computer 100 holds the address translation information that is transferred thereto by the memory controller 200 (step S912).

The memory controller 200 holds the access frequency information that is read from the nonvolatile memory 300 according to the initialization command from the host computer 100 (step S934).

The host computer 100 issues an initialization command in which the transfer destination is set to the host computer 100, and supplies the initialization command to the memory controller 200. The memory controller 200 reads the free physical address information from the nonvolatile memory 300 according to the initialization command, and transfers the free physical address information to the host computer 100. The host computer 100 holds the free physical address information that is transferred thereto (step S917).

The memory controller 200 holds the free physical address information according to the initialization command from the host computer 100 (step S936), and holds a portion of the address translation information (step S938).

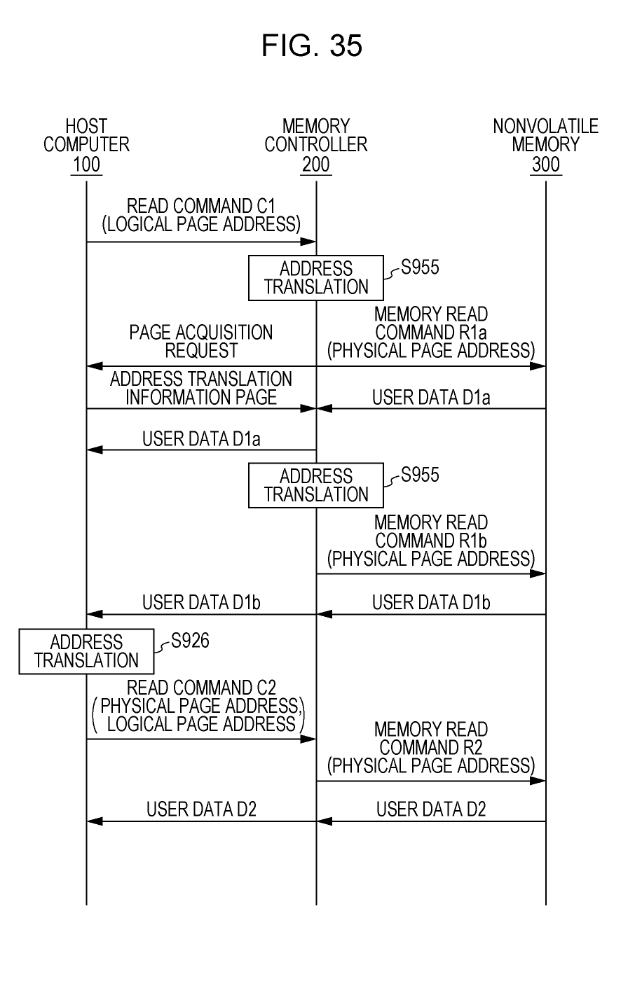

FIG. 35 is an example of a sequence diagram showing operations of the information processing system during reading of the user data in the second embodiment. It will be assumed that the read commands C1 and C2, each specifying different logical page addresses, are issued in order. It will be assumed that the transfer pages number of the read command C1 is 2 pages, and that the transfer pages number of the read command C2 is 1 page. It will be assumed that an entry corresponding to a logical page address L2 of the read command C2 is not held in the memory controller 200.

Since the transfer pages number of the read command C1 is 2 pages, the logical page address is translated into the physical page address by the memory controller 200 in the same manner as in the first embodiment.

On the other hand, since the transfer pages number of the read command C2 is 1 page, the host computer 100 translates the logical page address L2 of the read command C2 into the physical page address P2 (step S926). The host computer 100 supplies the read command C2 containing the logical page address L2 and the physical page address P2 to the memory controller 200. The memory controller 200 generates a memory read command R2 that specifies the physical page address P2, and supplies the memory read command to the nonvolatile memory 300. The memory controller 200 updates the access frequency of the logical page address L2.

According to the second embodiment, since the host computer 100 performs the address translation when the data size of the transfer data is less than the predetermined size, it is not necessary for the memory controller 200 to acquire the entry of the address translation information. Accordingly, when the data size of the transfer data is less than the predetermined size, the delay in the data transfer time caused due to the acquisition of the entry is suppressed.

It is assumed that the address translation information that is recorded on the nonvolatile memory 300 in the embodiments described above is held in the address translation information holding region 131 of the host computer 100. However, in the holding of the address translation information, encryption and the addition of error detection codes may be performed in order to prevent unexpected updates or access from outside. In this case, the circuits and programs for realizing each of the functions of encryption, decryption, the addition of error detection codes, and error detection are located in the host computer 100 or the memory controller 200.

Note that, the embodiments described above show examples for realizing the present disclosure, and the items in the embodiments and the specific items of the present disclosure in the scope of the claims correspond to one another. Similarly, the specific items of the present disclosure in the scope of the claims and the items in the embodiments of the present disclosure that have the same name correspond to one another. However, the present disclosure is not limited to the embodiments, and it is possible to realize the present disclosure by subjecting the embodiments to various modifications without departing from the spirit thereof.

The procedures described in the above embodiments can be interpreted as a method including the series of procedures, and can also be interpreted as a program for causing a computer to execute the series of procedures and as a recording medium storing the program. It is possible to use a Compact Disc (CD), a MiniDisc (MD), a Digital Versatile Disc (DVD), a memory card a Blu-ray Disc (tm) or the like as the recording medium.

The present disclosure may adopt the following configurations.

(1) A memory control device that includes an address translation information holding portion that holds a portion of entries that are selected from address translation information containing a plurality of entries that associate a logical address with a physical address of a memory device; an address translation information acquisition unit that, when the entry containing the logical address specified by a host computer is not held in the address translation information holding portion, acquires the entry that is not held from the host computer and causes the address translation information holding portion to hold the entry; an address translation unit that translates the specified logical address into the physical address on the basis of the entries that are held in the address translation information holding portion; and a data transfer unit that executes a data transfer process in which transfer data is transferred using the translated physical address.

(2) The memory control device according to (1) that further includes an access frequency holding portion that, for each entry, holds an access frequency in relation to the logical address corresponding to the entry, in which the data transfer unit further executes an initialization process including a process of selecting a portion of the entries, prioritizing the entries where the access frequency is high, and causing the address translation information holding portion to hold the selected entries.

(3) The memory control device according to (2), in which the data transfer unit executes an initialization process that further includes a process of acquiring all the entries from the memory device, and transferring the entries to the host computer.

(4) The memory control device according to any one of (1) to (3), in which an address that is specified by the host computer is the physical address or the logical address, in which, when the address that is specified by the host computer is the logical address, the address translation unit translates the logical address that is specified into the physical address on the basis of the entries, and in which the data transfer unit transfers the transfer data using a physical address that is specified by the host computer or the translated physical address.

(5) The memory control device according to (4), in which an address that is specified by the host computer is either the logical address and the physical address or the logical address, and, when the address that is specified by the host computer is the logical address and the physical address, the address translation unit updates the entry corresponding to the specified logical address on the basis of the specified physical address.

(6) The memory control device according to (4), in which the host computer supplies the memory control unit with a command specifying the physical address or the logical address, and a notification indicating the logical address and the physical address that is newly allocated to the logical address, and in which, when the notification is supplied to the address translation unit, the address translation unit updates the entry corresponding to the logical address indicated by the notification on the basis of the physical address indicated by the notification.

(7) A host computer that includes a holding portion that holds address translation information containing a plurality of entries that associate a logical address with a physical address of a memory device; an address translation unit that, when a data size of transfer data that is transferred between the memory device and the host computer is less than a predetermined size, translates the logical address into the physical address on the basis of the entries that are held; and a command unit that specifies the logical address or the converted physical address and instructs a memory control device to transfer the transfer data.

(8) The host computer according to (7) that further includes an address translation information management unit that supplies the memory control device with a notification indicating the logical address and the physical address that is newly allocated to the logical address; in which the holding unit further holds the physical address to which the logical address is not allocated as a free physical address, and in which, when a physical address is not associated with the logical address, the address translation unit newly allocates the free physical address to the logical address.

(9) The host computer according to (7), in which, when the data size of the transfer data that is transferred between the memory device and the host computer is less than the predetermined size and the physical address is not associated with the logical address, the address translation unit translates the logical address into the physical address on the basis of the entries that are held.

(10) An information processing system that includes a host computer that holds address translation information containing a plurality of entries that associate a logical address with a physical address of a memory device, an address translation information holding portion that holds a portion of entries that are selected from the address translation information; an address translation information acquisition unit that, when the entry containing the logical address specified by the host computer is not held in the address translation information holding portion, acquires the entry that is not held from the host computer and causes the address translation information holding portion to hold the entry; an address translation unit that translates the specified logical address into the physical address on the basis of the entries that are held in the address translation information holding portion; and a data transfer unit that executes a data transfer process in which transfer data is transferred using the translated physical address.

(11) A method of controlling a memory control device that includes an address translation information procedure acquiring in which, when an entry containing a logical address specified by a host computer is not held in an address translation information holding portion that holds a portion of the entries that are selected from address translation information containing a plurality of entries that associate the logical address with a physical address of a memory device, an address translation information acquisition unit acquires the entry that is not held from the host computer and causes the address translation information holding portion to hold the entry; an address translating procedure in which an address translation unit translates the specified logical address into the physical address on the basis of the entries that are held in the address translation information holding portion; and a data transferring procedure in which a data transfer unit executes a data transfer process in which transfer data is transferred using the translated physical address.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A memory control device, comprising:
an address translation information holding portion that holds a portion of entries that are selected from address translation information containing a plurality of entries that associate a logical address with a physical address of a memory device;
an address translation information acquisition unit that, when the entry containing the logical address specified by a host computer is not held in the address translation information holding portion, acquires the entry that is not held from the host computer and causes the address translation information holding portion to hold the entry;
an address translation unit that translates the specified logical address into the physical address on the basis of the entries that are held in the address translation information holding portion; and
a data transfer unit that executes a data transfer process in which transfer data is transferred using the translated physical address.

2. The memory control device according to claim 1, further comprising:
an access frequency holding portion that, for each entry, holds an access frequency in relation to the logical address corresponding to the entry,
wherein the data transfer unit further executes an initialization process including a process of selecting a portion of the entries, prioritizing the entries where the access frequency is high, and causing the address translation information holding portion to hold the selected entries.

3. The memory control device according to claim 2,
wherein the data transfer unit executes an initialization process that further includes a process of acquiring all the entries from the memory device, and transferring the entries to the host computer.

4. The memory control device according to claim 1,
wherein an address that is specified by the host computer is the physical address or the logical address,
wherein, when the address that is specified by the host computer is the logical address, the address translation unit translates the logical address that is specified into the physical address on the basis of the entries, and
wherein the data transfer unit transfers the transfer data using a physical address that is specified by the host computer or the translated physical address.

5. The memory control device according to claim 4,
wherein an address that is specified by the host computer is either the logical address and the physical address or the logical address, and
wherein, when the address that is specified by the host computer is the logical address and the physical address, the address translation unit updates the entry corresponding to the specified logical address on the basis of the specified physical address.

6. The memory control device according to claim 4,
wherein the host computer supplies the memory control unit with a command specifying the physical address or the logical address, and a notification indicating the logical address and the physical address that is newly allocated to the logical address, and
wherein, when the notification is supplied to the address translation unit, the address translation unit updates the entry corresponding to the logical address indicated by the notification on the basis of the physical address indicated by the notification.

7. A host computer, comprising:
a holding portion that holds address translation information containing a plurality of entries that associate a logical address with a physical address of a memory device;
an address translation unit that, when a data size of transfer data that is transferred between the memory device and the host computer is less than a predetermined size, translates the logical address into the physical address on the basis of the entries that are held; and
a command unit that specifies the logical address or the converted physical address and instructs a memory control device to transfer the transfer data.

8. The host computer according to claim 7, further comprising:
an address translation information management unit that supplies the memory control device with a notification indicating the logical address and the physical address that is newly allocated to the logical address,
wherein the holding unit further holds the physical address to which the logical address is not allocated as a free physical address, and
wherein, when a physical address is not associated with the logical address, the address translation unit newly allocates the free physical address to the logical address.

9. The host computer according to claim 7,
wherein, when the data size of the transfer data that is transferred between the memory device and the host computer is less than the predetermined size and the physical address is not associated with the logical address, the address translation unit translates the logical address into the physical address on the basis of the entries that are held.

10. An information processing system, comprising:
a host computer that holds address translation information containing a plurality of entries that associate a logical address with a physical address of a memory device;
an address translation information holding portion that holds a portion of entries that are selected from the address translation information;
an address translation information acquisition unit that, when the entry containing the logical address specified by the host computer is not held in the address translation information holding portion, acquires the entry that is not held from the host computer and causes the address translation information holding portion to hold the entry;
an address translation unit that translates the specified logical address into the physical address on the basis of the entries that are held in the address translation information holding portion; and
a data transfer unit that executes a data transfer process in which transfer data is transferred using the translated physical address.

11. A method of controlling a memory control device, comprising:
an address translation information acquiring procedure in which, when an entry containing a logical address specified by a host computer is not held in an address translation information holding portion that holds a portion of the entries that are selected from address translation information containing a plurality of entries that associate the logical address with a physical address of a memory device, an address translation information acquisition unit acquires the entry that is not held from the host computer and causes the address translation information holding portion to hold the entry;
an address translating procedure in which an address translation unit translates the specified logical address into the physical address on the basis of the entries that are held in the address translation information holding portion; and
a data transferring procedure in which a data transfer unit executes a data transfer process in which transfer data is transferred using the translated physical address.
